(19) United States
(12) Patent Application Publication
(10) Pub. No.: US 2021/0174037 A1
(43) Pub. Date: Jun. 10, 2021

(54) DYNAMIC RADIO FREQUENCY IDENTIFICATION DEVICE AND SYSTEM

(71) Applicant: Z Tech, Inc., Chicago, IL (US)

(72) Inventors: Cody A. Horchak, Chicago, IL (US); Eugene Rohrwasser, Chicago, IL (US); Frank Annerino, Palatine, IL (US)

(21) Appl. No.: 17/116,456

(22) Filed: Dec. 9, 2020

Related U.S. Application Data
(60) Provisional application No. 62/946,379, filed on Dec. 10, 2019.
(60) Provisional application No. 62/946,253, filed on Dec. 10, 2019.

(51) Int. Cl. G06K 7/10; G06K 19/07; G06K 19/06

(52) U.S. Cl. CPC G06K 7/10386; G06K 19/06009; G06K 19/0723; G06K 7/10297

(57) ABSTRACT

A universal radio frequency identification reader and emulation handheld device and system configured to read and emulate radio frequency identification tags in the low frequency, high frequency, and ultra-high frequency spectrums. The system may include a mobile or a web application to control and interact with the handheld device. The mobile application may receive an identifier of an RFID tag, upload the identifier to a server, determine, via the server a chip/identifying number of the RFID, and command an RFID emulator to emulate an RFID tag based on the received chip/identifying number.

### CROSS REFERENCE TO RELATED APPLICATIONS

This application claims priority to the following application(s), each of which is hereby incorporated by reference:

U.S. provisional patent application Ser. No. 62/946,379 titled “Dynamic Radio Frequency Identification Device And System” filed on Dec. 10, 2019; and U.S. provisional patent application Ser. No. 62/946,253 titled “Dynamic Radio Frequency Identification Device And System” filed on Dec. 10, 2019.

### BACKGROUND

The present disclosure relates to radio frequency identification readers and emulators and systems for controlling and using the disclosed radio frequency identification readers and emulators.

Radio frequency identification (“RFID”) has become increasingly ubiquitous in all industries. RFID devices may use various operating frequencies, for example low frequency, high frequency, and ultra-high frequency. Further, various manufacturers or issuers of radio frequency identification devices may use various communication protocols. Presently, multiple different RFID readers may be required to read RFID tags that use the various operating frequencies and communication protocols. Further, various RFID tags may be required for different purposes to operate with various RFID readers. Accordingly the present disclosure relates to a device and system that may read and emulate various RFID devices, and novel uses therefor.

### SUMMARY OF THE INVENTION

The present disclosure relates to universal radio frequency identification readers and emulators as well as systems for RFID tag data and controlling and using the disclosed RFID readers and emulators, as illustrated by and described in connection with at least one of the figures, as set forth more completely in the claims.

No known devices currently exist that may read low frequency, high frequency, and ultra-high frequency RFID tags, and/or emulate low frequency, high frequency, and ultra-high frequency RFID tags in a single device. No known systems currently exist that can obtain RFID data from an RFID card and then emulate the RFID card with a dynamic RFID emulator device.

### BRIEF DESCRIPTION OF THE DRAWINGS

FIG. 1 is a block diagram of an example radio frequency identification reader and emulator system.

FIG. 2a is an illustration of an exterior view of an example radio frequency identification reader and emulator.

FIG. 2b is an illustration of an exterior view of an example radio frequency identification reader and emulator.

FIG. 2c is an illustration of a view of an example interior of a casing of a radio frequency identification reader and emulator.

FIG. 2d is an illustration of an example control button of an example radio frequency identification reader and emulator.

FIG. 2e is an illustration of a view of an example interior of a casing of a radio frequency identification reader and emulator.

FIG. 3a is an illustration of a top view of an example circuit board of a radio frequency identification reader and emulator.

FIG. 3b is an illustration of a bottom view of an example circuit board of a radio frequency identification reader and emulator.

FIG. 4 is an illustration of an example circuit board within a casing of a radio frequency identification reader and emulator.

FIG. 5 is an illustration of an example antenna assembly of a radio frequency identification reader and emulator.

FIG. 6 is an illustration of an example circuit board, battery, and antenna assembly within a casing of a radio frequency identification reader and emulator.

FIG. 7 is an illustration of an example exploded view of a circuit board, battery, and antenna assembly within a casing of a radio frequency identification reader and emulator.

FIG. 8 is a block diagram of an example radio frequency identification reader and emulator system

FIG. 9 is a flowchart representative of an example method of reading a radio frequency identification tag using a radio frequency identification reader and emulator.

FIG. 10 is a flowchart representative of an example method of reading a radio frequency identification tag using a radio frequency identification reader and emulator.

FIG. 11 is a flowchart representative of an example method of storing radio frequency identification tag information in cloud infrastructure for later use and/or access.

FIG. 12 is a flowchart representative of an example method of emulating a radio frequency identification tag using a radio frequency identification reader and emulator.

FIG. 13 is a flowchart representative of an example method of emulating a radio frequency identification tag using a radio frequency identification reader and emulator.

FIG. 14a is an illustration of an example circuit board which includes an LF antenna, and HF antenna, and a UHF antenna.

FIG. 14b is an illustration of an example view of a circuit board and battery within a casing of a radio frequency identification reader and emulator.

FIG. 15 is a block diagram of an example system for emulating a physical proximity identification card.

FIG. 16 is a flowchart of an example method of emulating a physical proximity identification card.

FIG. 17 is a block diagram of an example access system that utilizes Bluetooth and RFID emulators and readers.

FIG. 18 is a flowchart of an example method for granting access using the example system illustrated in FIG. 17.

The figures are not necessarily to scale. Where appropriate, similar or identical reference numbers are used to refer to similar or identical components.

### DETAILED DESCRIPTION

The present disclosure relates to radio frequency identification (“RFID”) device(s) that may read and/or emulate RFID devices of various operating frequencies and communication protocols (i.e., a universal RFID device). The radio frequency identification device(s) may read and/or emulate one or multiple frequencies ranges of radio frequency. RFID devices are commonly used in various fields and application. For example, radio frequency identification devices may be used in access cards/keys/fobs in the hotel industry, commercial and residential buildings, offices, private residences, private clubs, gyms, or public transportation. RFID devices may also be used to access parking garages and parking lots. RFID devices may also be used in highway toll passes. RFID devices may also be used to track inventory. RFID devices may also be used in payments systems. For example, RFID devices may be used in credit cards. The uses and applications of RFID devices are constantly expanding. RFID refers to radio frequency as it pertains to identification, but the term RFID typically includes three standard frequencies. Furthermore, various RFID devices may operate in various frequency bands. For example, low frequency (“LF”) RFID devices typically operate between 30 kHz and 150 kHz, and more specifically between 125 kHz and 134 kHz. High frequency (“HF”) RFID devices, including Near-Field communication (“NFC”) typically operate at approximately 13.56 MHz, and ultra-high frequency (“UHF”) RFID devices typically operate at 858 MHz to 930 MHz. Although LF, HF, and UHF are the standard frequencies within RFID, there are many frequencies in between the LF and UHF frequencies, as well as slightly below LF and slightly above UHF, and there are use cases around those additional frequencies that add to identification. For example, radio frequency is used in car keys, garage door openers, alarm remotes, remote lighting, push-to-start proximity car keys, wireless chimes, and wireless sensors. Most of these devices operate using radio frequency including in the ranges or in between, but all generally under 1 GHz (1050 MHz). Different manufacturers or issuers may use different communication protocols and data formats. Accordingly, operators may need to carry multiple RFID devices for various applications. Therefore, a device that may emulate various RFID devices in a single compact device is desirable.

Disclosed example mobile devices include: a mobile application configured to: receive information corresponding to an identifier of an RFID tag; and communicate an emulate command to an RFID emulator based on the received identifier.

In some example disclosed mobile devices, the information corresponding to the physical identifier is input by a user into the mobile application via the mobile device.

In some example disclosed mobile devices the mobile device includes a camera, and the mobile application receives the information corresponding to the physical identifier from a picture taken of the RFID tag by the camera.

In some example disclosed mobile devices the mobile application communicates with the RFID emulator via one of Bluetooth NFC, Wi-Fi or Ultra WideB and.

In some example disclosed mobile devices the mobile application is further configured to: upload the identifier to a server to determine a chip/identifying number corresponding to the RFID tag; and receive the chip/identifying number from the server; and the emulate command is based on the received chip/identifying number

In some example disclosed mobile devices the mobile application is further configured to upload RFID tag manufacturer or issuer identification information to the server.

In some example disclosed mobile devices the server determines the chip/identifying number by requesting the chip/identifying number corresponding to the identifier from a manufacturer or an issuer database, where the manufacturer or issuer is selected based on the manufacturer or issuer identification information.

In some example disclosed mobile devices the server determines the chip/identifying number by requesting the information corresponding to the physical identifier from a manufacturer or an issuer database, wherein the manufacturer or issuer is selected based in part on the identifier.

Disclosed example systems include: a server; a universal RFID device; and a mobile application configured to: receive information corresponding to an identifier of an RFID tag; upload the physical identifier information to the server, wherein the server is configured to determine a chip/identifying number of the RFID tag based on the identifier; receive the chip/identifying number of the RFID tag from the server; and communicate an emulate command to the universal RFID device based on the received unique serial code.

In some disclosed example systems, the information corresponding to the physical identifier is input by a user into the mobile application.

In some disclosed example systems, the mobile application receives information corresponding to the physical identifier from a picture taken of the RFID tag.

In some disclosed example systems, the mobile application communicates with the server via webservices.

In some disclosed example systems, the mobile application further uploads RFID tag manufacturer or issuer identification information to the server.

In some disclosed example systems, the server determines the chip/identifying number by requesting the information corresponding to the identifier from a manufacturer or an issuer database, and the manufacturer or issuer is selected based on the manufacturer or issuer identification information

In some disclosed example systems, the server determines the chip/identifying number by requesting the serial code corresponding to the physical identifier from a manufacturer or an issuer database, and the manufacturer or issuer is selected based in part on the physical identifier.

Disclosed example methods include: receiving, at a mobile application, an identifier of an RFID tag; uploading the identifier from the mobile application to a server; determining, via the server, a chip/identifying number of the RFID tag based on the physical identifier; and storing, in a database hosted on the server, the chip/identifying number and the identifier.

Some disclosed example methods further include sending the chip/identifying number and the identifier to the mobile application.

Some disclosed example methods further include emulating, via an RFID emulator in communication with the mobile application, the RFID tag.

In some disclosed example methods, the mobile application communicates with the server via webservices.

Disclosed example access systems include: an RFID reader; and an RFID emulator affixed to a location in proximity to the RFID reader, the RFID emulator configured to: receive emulation information from a mobile application; and emulate an RFID access card based on the emulation information

Some disclosed example access systems include: at least one of an NFC chip or a BLE Chip in communication with the RFID emulator.

In some example disclosed access systems, the NFC chip or BLE Chip is configured to send a first signal from the mobile application when a device running the mobile application is placed within a threshold proximity of the NFC chip or BLE Chip.

In some example disclosed access systems, the NFC chip or BLE Chip communicates location to a mobile application that communicates with an emulator in response to receiving the first signal, and the emulator emulates the RFID access card in response to receiving the enable signal.

In some example disclosed access systems, the NFC chip or BLE Chip communicates a unique location identifier to an RFID emulator.

In some example disclosed access systems, the RFID emulator communicates with the mobile application via one of Bluetooth NFC, Wi-Fi or Ultra WideB and.

In some example disclosed access systems, the emulation information comprises a chip/identifying number.

Disclosed example access systems include: a first RFID reader; a first RFID emulator affixed to a first location in proximity to the first RFID reader, the first RFID emulator configured to: receive emulation information from a mobile application; and emulate an RFID access card based on the emulation information; a second RFID reader; and a second RFID emulator affixed to a second location in proximity to the second RFID reader, the second RFID emulator configured to: receive emulation information from the mobile application; and emulate the RFID access card based on the emulation information.

In some example disclosed access systems, the first RFID emulator and the second RFID emulator are configured to communicate with the mobile application via one of Bluetooth NFC, Wi-Fi or Ultra WideBand.

In some example disclosed access systems, the first RFID emulator communicates with the second RFID emulator via one of Bluetooth NFC, Wi-Fi or Ultra WideBand.

In some example disclosed access systems, the first RFID emulator communicates emulation information received from the mobile application to the second RFID emulator.

Some disclosed example access systems further include: at least one of a first NFC chip and/or a first BLE Chip configured to communicate a first location of the first RFID emulator and at least one of a second NFC chip or a second BLE Chip configured to communicate a second location of the second RFID emulator.

In some example disclosed access systems, the first NFC chip or BLE Chip is configured to send a first signal to the mobile application when a device running the mobile application is placed within a threshold proximity of the first NFC chip or BLE Chip, and the second NFC chip or BLE Chip is configured to send a second signal to the mobile application when a device running the mobile application is placed within a threshold proximity of the second NFC chip and/or BLE Chip

In some example disclosed access systems, the first emulator is configured to transmit a first request for emulation information in response to receiving the first signal, and the second emulator is configured to transmit a second request from emulation information in response to receiving the second signal.

In some example disclosed access systems, the first emulator is configured to emulate the RFID access card in response to receiving the emulation information and the first signal, and the second RFID access card is configured to emulate the RFID access card in response to receiving the emulation information and the second signal.

In some example disclosed access systems, each of the first emulator and the second emulator store the emulation information in memory for a threshold amount of time after receiving the emulation information.

In some example disclosed access systems, each of the first emulator and the second emulator comprises a unique location identifier, and wherein the first request and the second request include the corresponding unique location identifier.

In some example disclosed access systems, the emulation information includes a user identifier and a chip/identifying number.

In some example disclosed access systems, the emulation information is deleted after a threshold amount of time after receiving the emulation information.

In some example disclosed access systems, the emulation information is deleted after an emulation.

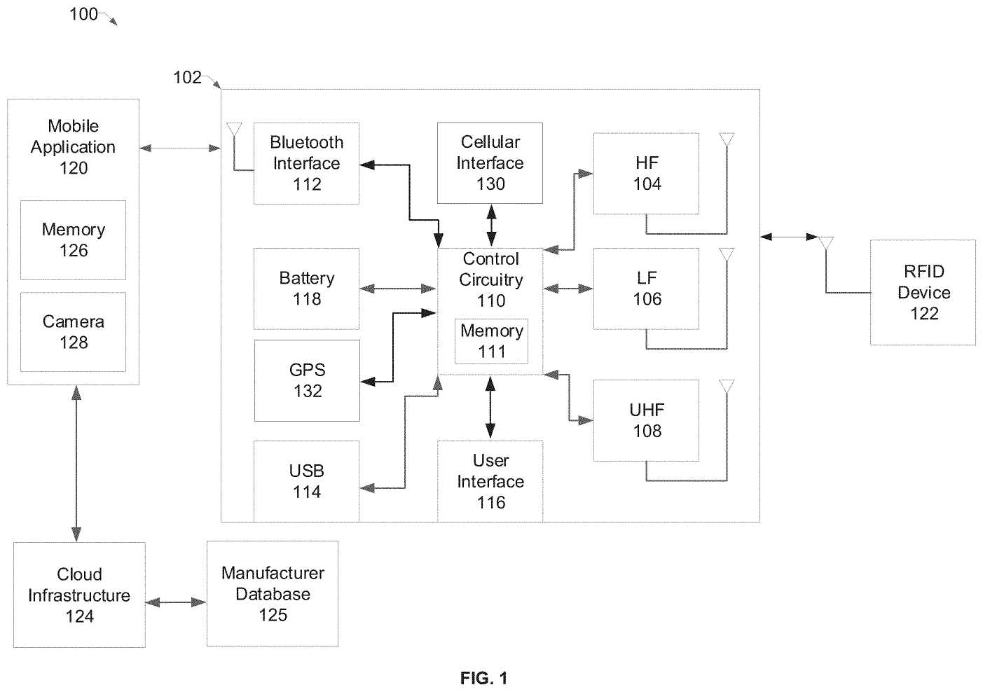

FIG. 1 illustrates a block diagram of an example radio frequency identification emulation system 100. The system 100 includes a dynamic radio frequency identification tag device (“HDT”) 102, which includes HF circuitry 104 including an HF antenna, LF circuitry 106 including an LF antenna, and UHF circuitry 108 including a UHF antenna. Each of the HF circuitry 104, the LF circuitry 106, and the UHF circuitry 108 are connected to control circuitry 110. The HDT 102 may include circuitry (i.e., control circuitry 110 and UHF circuitry 108, or a chip that includes control circuitry 110 and UHF circuitry 108) that is able to communicate with frequencies ranging from 142 MHz to 1050 MHz. With certain configurations of antennas, the HDT 102 would be able to communicate with all radio frequencies below 1050 MHz by modifying the antenna(s). In some examples, the control circuitry 110 includes memory 111.

The example HDT 102 also includes a Bluetooth interface 112 (e.g., a Bluetooth Low energy interface support Generic Attributes (“GATT”) services), a universal serial bus (“USB”) interface 114, a user interface 116, and a battery 118. The Bluetooth interface 112 may be used to communicate with an application (i.e., a mobile application) 120 running on a smartphone, tablet computer, or other computing device. Although described as a Bluetooth interface, any suitable wireless communications circuitry may be used to communicate with a mobile application 120. In some examples, the USB interface 114 may also be used to communicate with an application 120 running on a smartphone, tablet computer, or other computing device. The user interface 116 may include a button and an indicator light. The HDT 102 may be powered by the battery 118. In some examples, the battery 118 may be charged via charging power received at the USB interface 114. In some examples, the battery 118 may be inductively charged.

The example HDT 102 may be capable of LF, HF, and UHF radio frequency identification (“RFID”) emulation. Accordingly, the HDT 102 may emulate an RFID signal that may be read by an RFID device 122, such as an RFID reader. The example HDT 102 may be compatible with HF, LF, and UHF RFID readers. The HDT 102 may also read an RFID device (i.e. read the data stored in an RFID tag).

An operator may control the HDT 102 via a mobile application 120. For example, and as explained in more detail below, an operator may command the HDT 102 to emulate a specific RFID tag via a mobile application 120. The RFID tag information, (which may include the tag identification chip/identifying number and tag type) is then communicated to the HDT 102 via the Bluetooth interface 112 (or via the USB interface 114). The control circuitry 110 then selects the appropriate circuitry with which to emulate the tag (the HF circuitry 104, LF circuitry 106, or UHF circuitry 108) based on the tag type. The tag information is transmitted via the corresponding antenna(s) (one of HF antenna, UHF antenna, LF antenna, or combination of the two of more antennas) to the RFID reader 122, thereby emulating the RFID tag.

In some examples, the control circuitry 110 includes a processor and a field-programmable gate array (“FPGA”). The processor may communicate with the Bluetooth interface 112 and communicate with and configure the FPGA. In some examples, the Bluetooth interface might be part of the processor. In some examples, the FPGA may also replace the processor. In such cases, the FPGA may also communicate directly with the Bluetooth interface 112. In some examples, a processor may also replace the FPGA. In some examples, a single processor might consolidate the processor, FPGA and Bluetooth interface.

The FPGA may be used to modulate and demodulate signals to read and emulate RFID devices. Accordingly, the FPGA may be connected to the HF circuitry 104, the LF circuitry 106, and the UHF circuitry 108. The processor may receive a command from the Bluetooth interface 112 and configure the FPGA according to the command from the Bluetooth interface 112. For example, the FPGA may be configured to operate at HF, LF, UHF, or a combination of two or more frequency ranges, based on the command received by the processor from the Bluetooth interface 112. The FPGA may then accordingly modulate a commanded signal to the antenna(s) (HF, LF, UHF, or two or more thereof) and corresponding circuitry (HF 104, LF 106, or UHF 108) in order to emulate an RFID device or transmit a carrier signal via the antenna(s) (HF, LF, UHF, or two or more thereof) and corresponding circuitry (HF 104, LF 106, or UHF 108) then demodulate the received response in order to read an RFID device. When reading a device, the FPGA may send the demodulated bits to the processor. The processor may then send the bits to the Bluetooth interface 112, which then transmits the bits to a mobile application 120. The antenna and corresponding circuitry (HF 104, LF 106, or UHF 108) may be selected based on the command the processor receives from the Bluetooth interface 112. In some examples, the FPGA may only be configured to operate with the HF circuitry 104 and the LF circuitry 106. In such examples, the UHF circuitry 108 may include circuitry to modulate and demodulate signals. In some examples, the FPGA may modulate and demodulate UHF signals. In such examples, the FPGA may send and receive modulated data to the UHF circuitry 108. In some examples, the processor may only be configured to operate with the HF circuitry 104 and the LF circuitry 106. In such examples, the UHF circuitry 108 may include circuitry to modulate and demodulate signals. In some examples, the processor may modulate and demodulate UHF signals. In such examples, the processor may send and receive modulated data to the UHF circuitry 108.

In some examples, the control circuitry 110 includes a processor (e.g., a DSP) configured to communicate directly with the HF circuitry 104 including the HF antenna, the LF circuitry 106 including the LF antenna, and the UHF circuitry 108 including the UHF antenna. In such examples, a switch may select the appropriate circuitry and antenna (HF 104, LF 106, or UHF 108) to use to read or emulate.

A mobile application 120 may also communicate with cloud infrastructure 124. The cloud infrastructure 124 may include accounts keyed to specific users. Each account may include information regarding which RFID tags may be emulated by the HDT 102. The cloud infrastructure 124 may then communicate the RFID tag information to the mobile application 120, which then can communicate the RFID tag information to the HDT 102 via the Bluetooth interface 112 (or USB 114). For example, an operator may have an access key containing a certain RFID tag which is used to unlock a door. The operator may upload the information included in the RFID tag to the operator's account in the cloud infrastructure 124. The operator may then download that tag information to the operator's mobile application 120, which can be stored in memory 126 on a mobile application 120. Then the operator may then use the mobile application 120 to command the HDT 102 to emulate the tag information to unlock the door, without the actual access key.

Similarly, an operator may share RFID tag information stored in the operator's account with a second operator by sending the RFID tag information to the second user's account. The second user may then unlock the door by downloading that RFID tag information from the second user's account via a mobile application 120 and then emulating the RFID tag information with the HDT 102 to unlock the door.

An operator may also read RFID tags using the HDT 102. For example, the HDT 102 may read, via the corresponding circuitry (HF 104, LF 106, or UHF 108), the tag information included in an RFID device 122. The HDT 102 may then send the read tag information to a mobile application 120. An operator may then save the tag information either locally in the mobile application 120 or upload the tag information to the operator's account in the cloud infrastructure 124. Accordingly, an operator may read an RFID tag 122 via the HDT 102 and save the tag information to the operator's account in the cloud infrastructure 124 and then allow access to that tag information to other operators. In some examples, an operator may read several RFID tags via the HDT 102, and store the information of each RFID in either the operator's account or locally on a mobile application 120. The operator may then emulate each stored tag as needed, eliminating the need to carry multiple RFID devices.

In some examples, a mobile application 120 may have access to a camera 128 of the mobile phone/tablet/computer running the mobile application 120. In some examples, an operator may take a picture of the RFID tag 122 with the camera 128, and the mobile application may automatically detect the tag type, thereby decreasing the time required to read the RFID tag 122. In some examples, the camera may be used to identify location of a HDT 102 device. For example, the camera may scan QR code or the like which may be used to indicate a location of the HDT 102 device. In some examples, the camera may be used to verify the user via facial recognition. In some examples, the tag information may be acquired from the access badge without ever needing to read the card, but instead by using the numbers printed on the badge to identify the tag information. In some examples, the tag information may be created by the HDT 102 device and via the corresponding circuitry (HF 104, LF 106, or UHF 108), to be learned by the readers to work with the HDT 102.

In some examples, a mobile application 120 may acquire the RFID tag 122 information from a database 125 maintained by the manufacturer or issuers of the RFID tag. The information associated with the RFID tag 122 may be communicated to the mobile application 120 from the manufacturer's or issuers database 125 through webservices which serve the data to the mobile application 120. Webservices may be hosted on the cloud infrastructure 124. Webservices securely communicate information over an internet connection between two connected devices, in this case the manufacturer's or issuer's cloud based database 125 and the mobile application 120. In some examples, the information from the manufacturer's or issuer's cloud database 125 may be organized in a database hosted on the cloud infrastructure 124 such that individual RFID tags are associated with their respective unique identifying number, specific location(s), and specific user(s). The unique identifying number associated with each individual RFID tag stored in the database on the cloud infrastructure 124 may be received from the manufacturer's or issuer's database 125. The unique identifying number associated with each individual RFID tag may also be manually read, by an HDT 102 and then uploaded to the database via the mobile application 120 in communication with the HDT 102 and the cloud infrastructure 124.

An operator may also read a status of the HDT 102 via a mobile application 120. For example, the HDT 102 may send a battery status to a mobile application 120. The HDT 102 device may also send usage information to a mobile application 120. The HDT 102 device may also send diagnostic information to q mobile application 120. In some examples, a mobile application 120 may provide a PIN code or link to activate the HDT 102. The HDT 102 may also indicate to a mobile application 120 whether it detects any RFID tags within the range of the HDT 102. A mobile application 120 may then give the user the option to read any RFID tag detected within the range of the HDT 102.

An operator may also update the firmware of the HDT 102 via the Bluetooth interface 112 or the USB interface 114. An operator may download an update via a mobile application 120 from the cloud infrastructure 124, and transfer the downloaded update information to the HDT 102 via the Bluetooth interface 112 or the USB interface 114. The HDT 102 may then download and install the update.

In some examples, the HDT 102 may include a cellular communication interface 130, for example a cellular IoT chip and may also include a global positioning (GPS″) system module 132. The cellular communication interface 130 may provide access to the internet such that the HDT 102 may communicate directly with the cloud infrastructure 124 (i.e. rather than communicating with the cloud infrastructure 124 via the Bluetooth interface 112 and a mobile application 120). In some examples, the cellular chip might be using a wireless radio frequency (RF) technology (e.g., LoRa or MIOTY network (900 MHz)). In such examples, the user interface 116 may include a display, for example a touchscreen display, which an operator may use to control the HDT 102. In such examples, the user interface 116 may include a digital assistant, for example artificial intelligence voice recognition assistant, which an operator may use to control the HDT 102. In such examples, an operator may access an account in the cloud infrastructure 124 directly from the HDT 102. For example, the operator may read an RFID tag and upload the RFID information directly to the cloud infrastructure 124. An operator may also download RFID information directly to the HDT 102 from the cloud infrastructure 124 in order to emulate an RFID tag (for example to access a garage or a door). The HDT 102 may also report its location, which is obtained via the GPS module 132, to the cloud infrastructure 124. . In some examples, the HDT 102 device may be accessed directly from a cloud infrastructure 124. In such examples, the cloud infrastructure 124 might be able to send RFID information directly to the HDT 102. The cloud infrastructure 124 may then communicate to the HDT 102 nearby parking lots, garages, or buildings, vehicles, etc., which may be accessed via emulating an RFID tag. The HDT 102 may then display such information to an operator via the user interface 116.

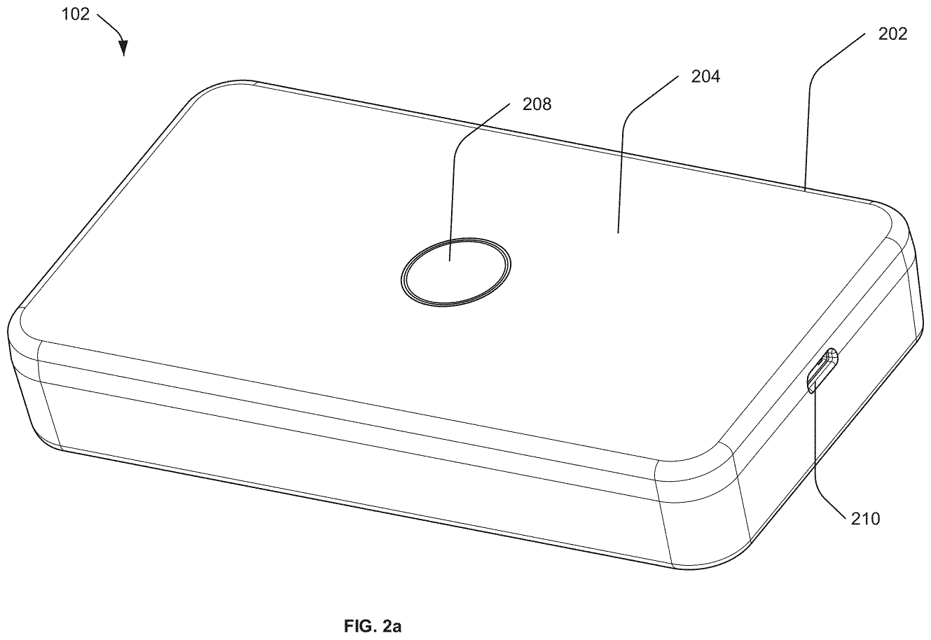

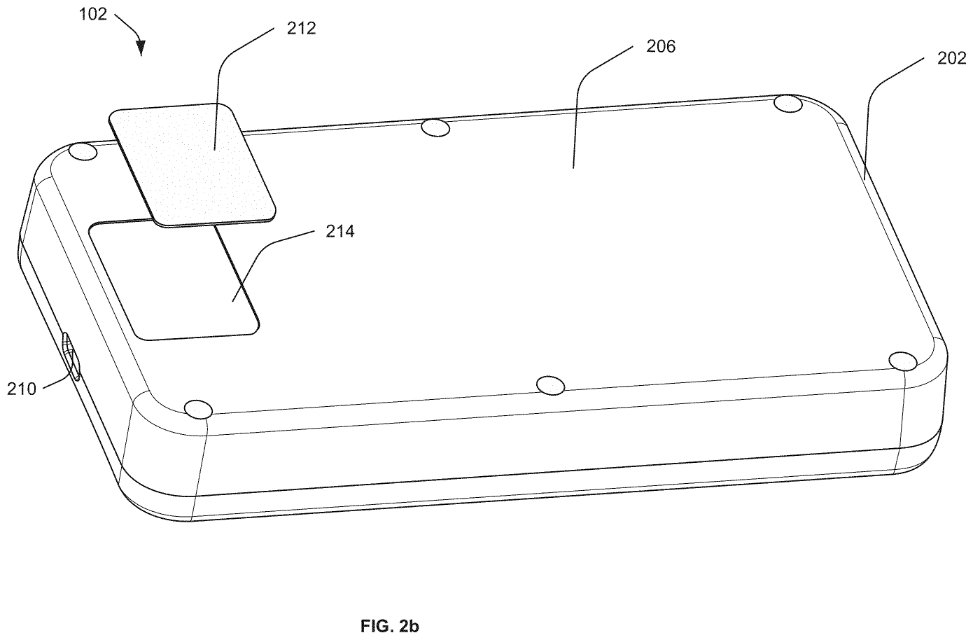

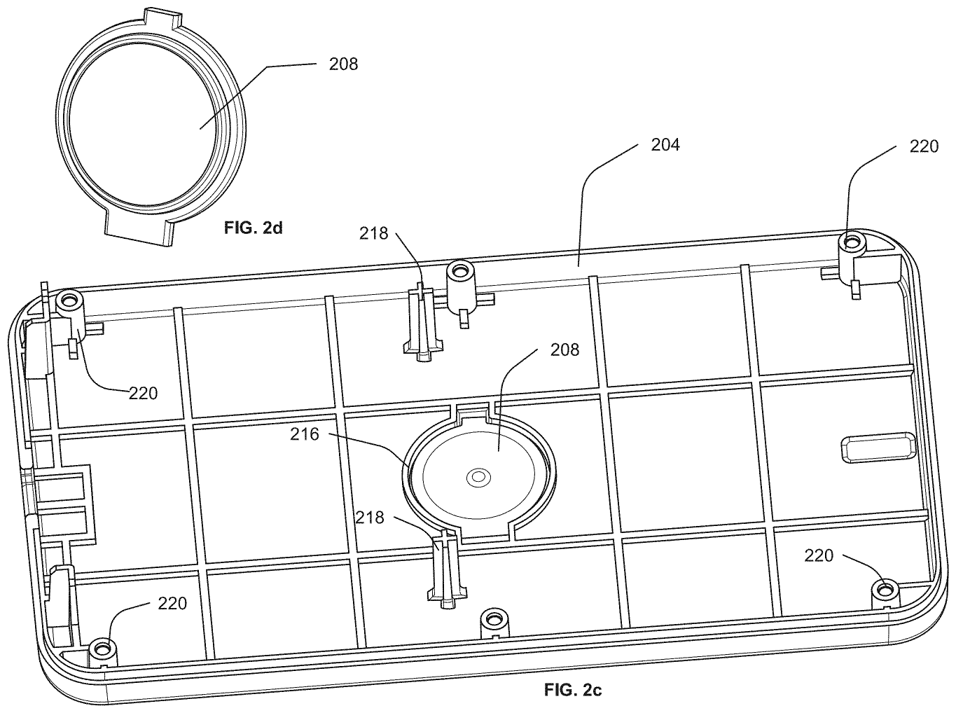

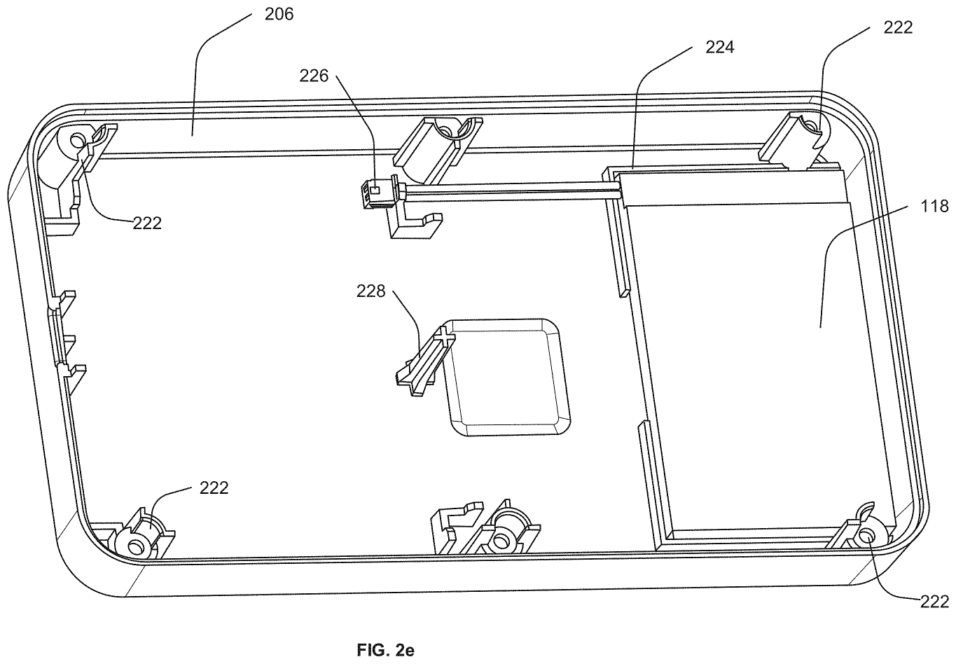

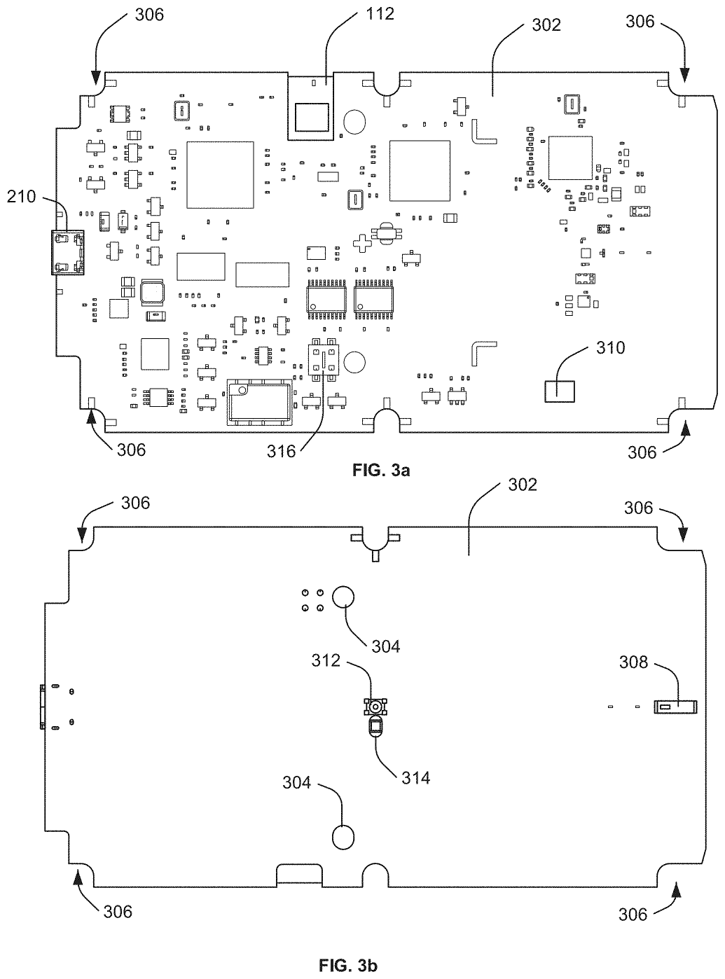

FIG. 2a illustrates a front view of an example dynamic radio frequency identification device, such as HDT 102 of FIG. 1. FIG. 2b illustrates a back view of the example dynamic radio frequency identification device. The HDT has a case 202. The case 202 may include a case front 204 and a case back 206. As illustrated, the case front 204 and case back 206 are configured to securely engage each other to form the protective outer case 202. The case 202 is designed to absorb impact such that the HDT 102 may operate normally after repeated drops. For example the case 202 may withstand repeated 6 foot drops onto concrete. Accordingly, the case 202 may be made of a suitable material such as a polymer to absorb impact, and the internal hardware may be secured within the case 202 to withstand repeated impact.

The case 202 may be handheld. Accordingly, the case 202 may be less than approximately 5 inches in height, 2.5 inches in width, and 1 inch thick. Further, the case 202 may have texturing on the outer surface in order to increase friction and prevent the case from slipping in an operator's grip.

The case front 202 may include a button 208. The button 208 may be used as a user interface 116 to wake the HDT 102 from a low-power mode. The HDT 102 may typically operate in a low-power mode to conserve battery 118 power. In some examples, when an operator decides to use the HDT 102, for example to connect the HDT to a mobile application 120 of FIG. 1, the operator may press the button 208 to wake the control circuitry 110 of the HDT 102 from the low-power mode and connect with a mobile application via the Bluetooth interface 112 (or USB 114). In some examples, the Bluetooth interface 112 might be able to wake the control circuitry 110 of the HDT 102 from the low-power mode and connect with a mobile application. In some examples, the HDT 102 might always be connected to a mobile application 120 via the wireless connection/Bluetooth interface 112. The operator may also wake the control circuitry 110 from a mobile application 120 via the wireless connection/Bluetooth interface 112. After a threshold period of non-use, for example several seconds or minutes without receiving any commands from a mobile application 120, the HDT 102 may enter the low-power mode. In some examples, in the low-power mode the circuitry of the HDT 102 may be powered off except for the button 208 detection circuitry and/or the Bluetooth interface 120. Detection of the button 208, or a signal received via the Bluetooth interface 112 from a mobile application 120, may then wake the HDT 102 from the low-power mode.

The case 202 also may include an input port 210 for the USB interface 114. In some examples, the USB port 210 may accept a USB-B connector. In some examples, the USB port 210 may accept a USB mini connector. In some examples, the USB port 210 may accept a USB micro connector. In some examples, the USB port 210 may accept a USB-A connector. In some examples, the USB port 210 may accept a USB-“C” connector. In some examples, there may be no USB interface ports. The battery 118 of the HDT 102 may be charged via power received via a USB connector connected to the USB port 210. In some examples, the battery 118 of the HDT 102 may be charged via inductance power. The HDT 102 may also communicate with a mobile application 120 via a connector connected to the USB port 210.

The illustrated case back 206 has a plate 212 and a pocket 214 into which to secure the plate 212. The plate 212 may include product chip/identifying number information and Federal Communication Commission compliance information. In some examples, product chip/identifying number information and Federal Communication Commission compliance information may be directly printed onto or engraved into the case 202. In some examples, the product chip/identifying number information and Federal Communication Commission compliance information may be on a sticker that may be applied to the case 202.

FIG. 2c illustrates an example view of the interior of the case front 204. The illustrated case front 204 has an aperture 216 configured to receive and securely hold a button 208 in such a way that the button may be pressed and released when the case front 204 is engaged to the case back 206. FIG. 2d illustrates an example button 208 configured to be secured to the aperture 216 of the case front 204 as illustrated in FIG. 2c. The illustrated interior of the case front 204 has cross ribs 218 configured to secure a circuit board to the case front 204. The cross ribs 218 may also support an antenna board. The case front 204 also has engagement pins 220 configured to engage with corresponding engagement pins on the case back 206 to secure the case front 204 to the case back 206. The position of the engagement pins 220 may also secure a circuit board in position in the case front 204.

FIG. 2e illustrates an example view of the interior of the case back 206. The case back includes engagement pins 222 configured to engage with corresponding engagement pins 220 on the case front 204 to secure the case front 204 to the case back 206. The case back 206 also includes a pocket 224 configured to hold the battery 118 of the HDT 102. The battery 118 may be secured to the case back 206 via an adhesive. The battery 118 is electrically connected to a battery connector 226 which connects to a circuit board to provide power to the circuit board and to receive charging power when the HDT 102 is connected to an external power source via the USB input port 210. The case back 206 also includes a cross rib 228 configured to secure an antenna board. The cross rib 228 may also support a main board. The position of the engagement pins 222 may also secure an antenna board in position in the case back 206.

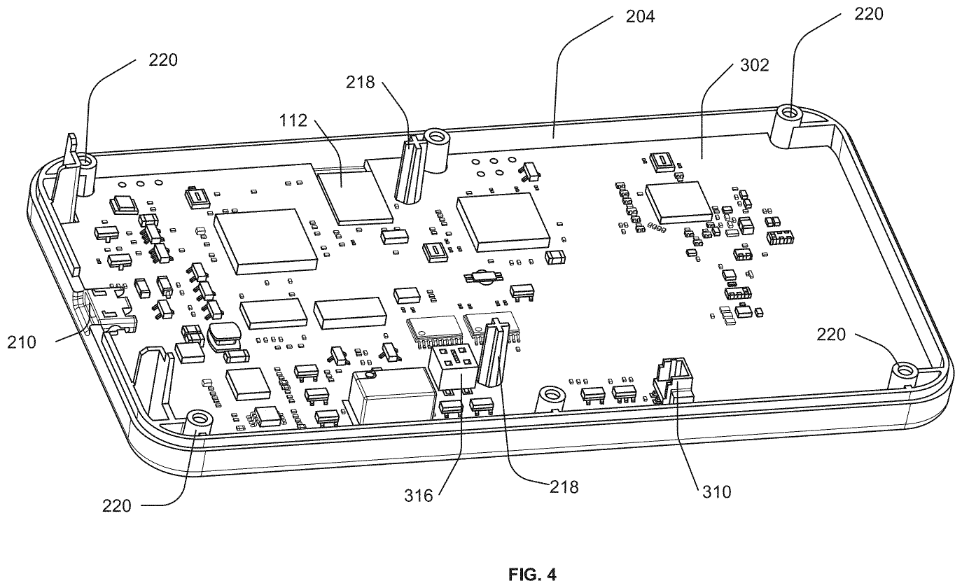

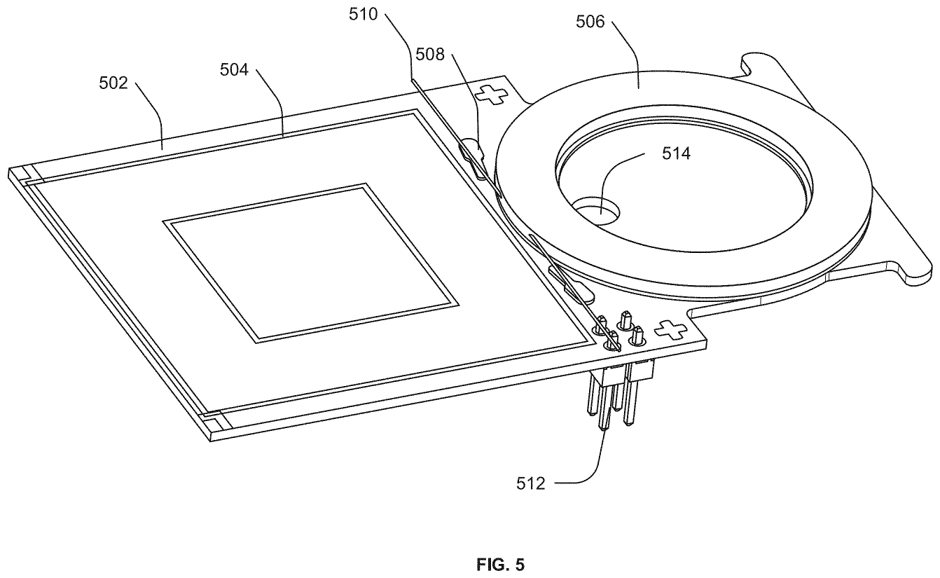

FIG. 3a illustrates a front view of an example circuit board 302 of the HDT 102, and FIG. 3b illustrates a back view of the example circuit board 302. The example circuit board includes a USB port 210 and a Bluetooth module/interface 112. The Bluetooth module 112 may be used to communicate with a mobile application 120. The example circuit board 302 includes apertures 304 to receive the cross ribs 218 of the case front 204 in order to secure the circuit board 302 into place within the case 202. The example circuit board 302 also includes slots 306 which are formed to fit securely to the engagement pins 220 of the case front 204 to secure the circuit board 302 into place within the case 202. The circuit board 302 also includes a UHF antenna 308 which may be a pattern printed onto the circuit board 302 and which is connected to UHF circuitry 108 and control circuitry 110 on the circuit board 302. The UHF antenna 308 may be a 902 MHz to 928 MHz antenna that meets the United States standard, and the UHF circuitry 108 may include a 900 MHz match circuit.) The UHF antenna 308 may be a 858 MHz to 960 MHz antenna that meets the International standard, and the UHF circuity 108 may include a 142 MHz-1050 MHz matching circuit.

The circuit board 302 also includes a battery connector 310, which may be electrically connected to the battery 118 to power the control circuitry 110, the HF circuitry 104, the LF circuitry 106, the UHF circuitry 108, and the Bluetooth interface 112. The battery connector 310 may also be used to charge the battery 118.

The example circuit board 302 also includes a switch 312. The switch 312 may be manipulated by an operator pressing the button 208 of FIGS. 2a-2d. In some examples, at least a portion of the button 208 is translucent. Accordingly, the circuit board 302 may include an indicator light 314 (e.g., an LED), which may indicate to an operator when the HDT 102 is in an operating mode or is in a low-power mode. For example, the indicator light 314 may turn on when the HDT is in an operating mode and off when in a low-power mode. In some examples, the indicator light 314 may be one color when in an operating mode and another color when in a low-power mode. In some examples, the indicator light 314 may flash at a set frequency and/or color to indicate status to an operator. For example, the indicator light 314 may flash at a set frequency and/or color when the HDT 102 is emulating and another set frequency and/or color when the HDT 102 is reading. In some examples, the indicator light 314 may flash at a set frequency and/or color to indicate to an operator that the battery 118 needs to be recharged.

The example circuit board 302 also includes a board-to-board (B TB) connector port 316. The BTB connector port 316 includes slots configured to receive pins from corresponding BTB connector pins of an antenna board in order to connect control circuitry 110 on the circuit board 302 to an antenna board including an HF antenna and a LF antenna.

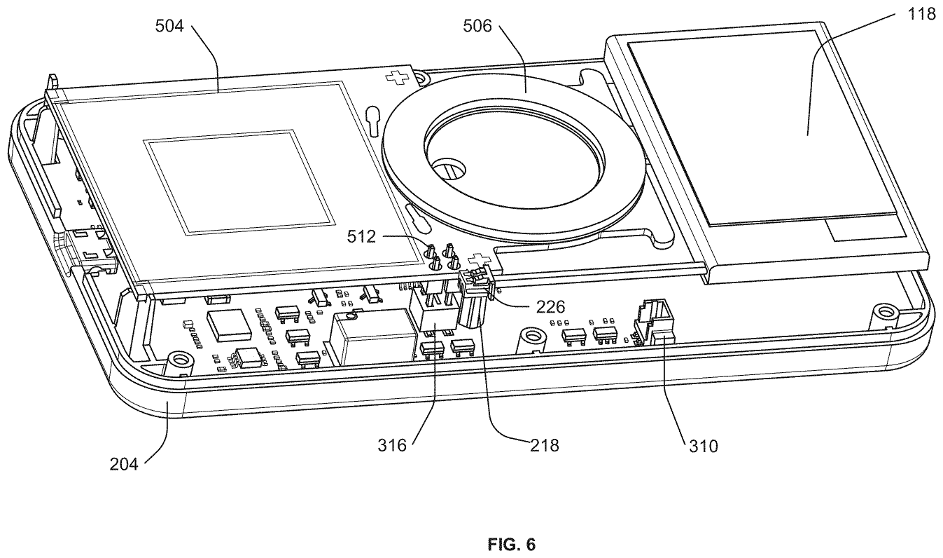

FIG. 4 illustrates the example circuit board 302 of FIGS. 3a-3b secured within the case front 204 of FIG. 2c. As illustrated, the cross ribs 218 are engaged with the apertures 304 and the engagement pins 220 are coupled to the slots 306 to secure the circuit board 302 to the case front 204.

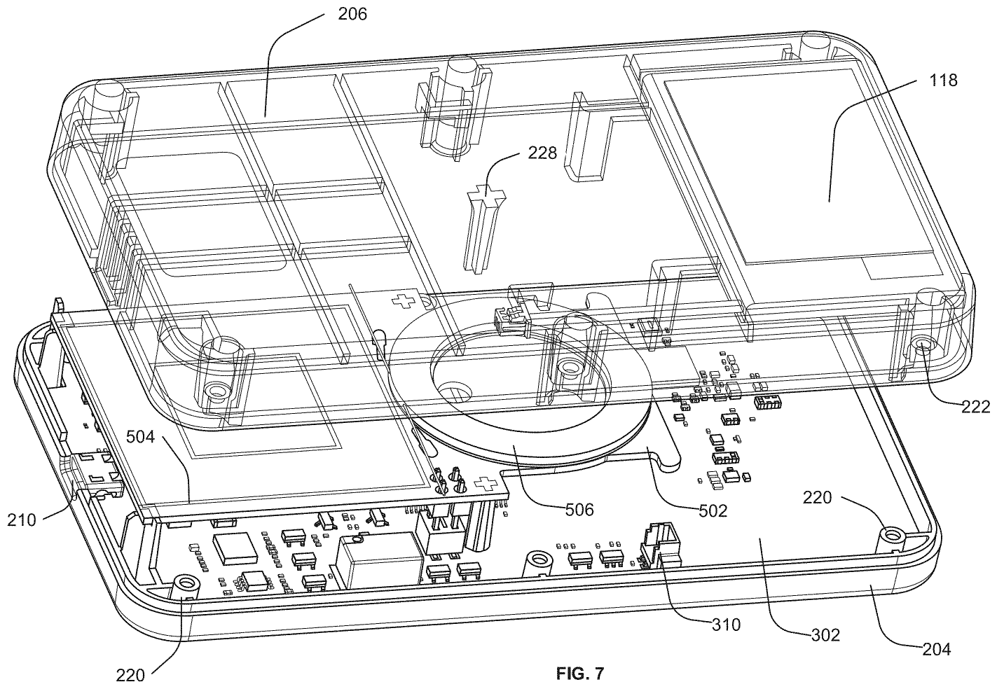

FIG. 5 illustrates an example antenna board 502. The antenna board includes an HF antenna 504 and an LF antenna 506. As illustrated, the HF antenna 504 may be a pattern printed onto the antenna board 502 (a printed circuit board). As illustrated, the LF antenna 506 may be secured to the antenna board via an adhesive. As displayed in FIG. 5, the HF antenna 504 and the LF antenna 506 may be adjacent. In some examples, the HF antenna 504 and the LF antenna 506 may overlap to conserve space and allow the HDT 102 to be smaller and more ergonomic while not sacrificing antenna functionality. For example, the LF antenna 506 may overlap the HF antenna 504 by 50 percent. The LF antenna 506 is connected to connector pads 508 via connection wires 510. In some examples, the LF antenna 506 may be a pattern printed onto the antenna board 502 (a printed circuit board). The connection wires 510 may be soldered to the connector pads 508. The connector pads 508 and the HF antenna 504 are electrically connected to the BTB connector pins 512. BTB connector pins 512 may be used to connect the antenna board 502 to control circuitry 110 on the circuit board 302 using BTB connector port 316 of FIG. 3a. The antenna board 502 may have an aperture 514 configured to receive a support rib (i.e. the support rib 228 of FIG. 2e) to secure the antenna board.

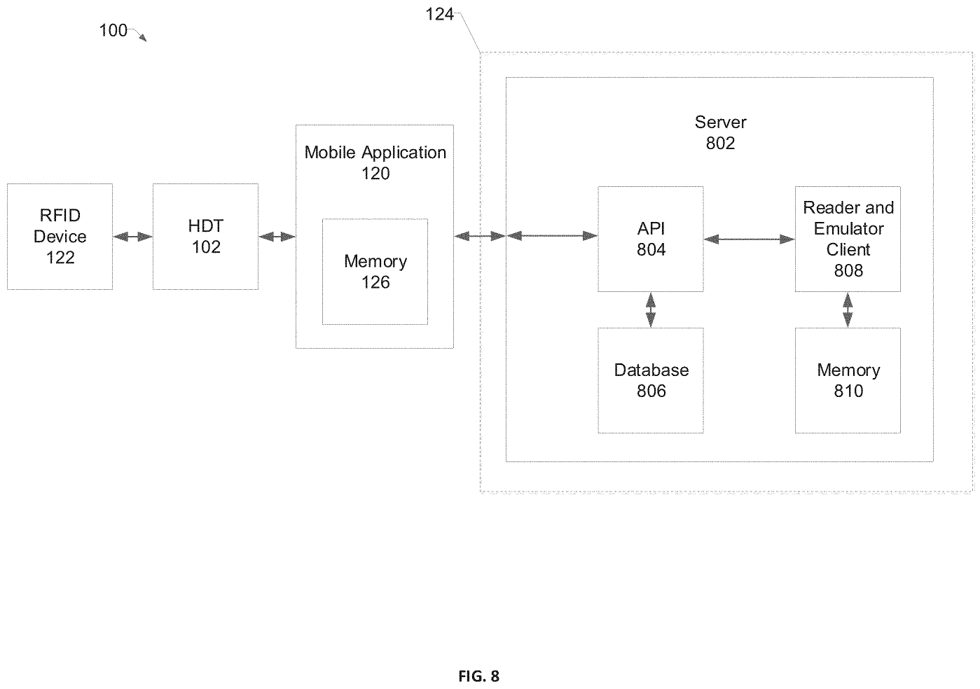

FIG. 6 illustrates an example view of the example circuit board 302 secured within the case front 204, and an example antenna board 502 connected to the circuit board. The view of FIG. 6 shows an example HDT 102 with the case back 206 hidden. As illustrated, the circuit board 302 is electrically connected to the antenna board 502 via the BTB connector port 316 and the BTB connector pins 512. The antenna board 502 is supported by cross ribs 218. The battery 118 is connected to control circuitry 110 on the circuit board 302 via engaging battery connector 226 to battery connector 310 of the circuit board 302.

As illustrated in FIG. 6, an example antenna board 502 may be offset from an example circuit board 302 sufficiently to allow the HF antenna 504 and the LF antenna 506 to properly resonate at the required frequencies. The offset may also be kept to a minimum in order to reduce the width of the HDT 102. In some examples, the HF antenna 504 and the LF antenna 506 might be part of the circuit board 302.

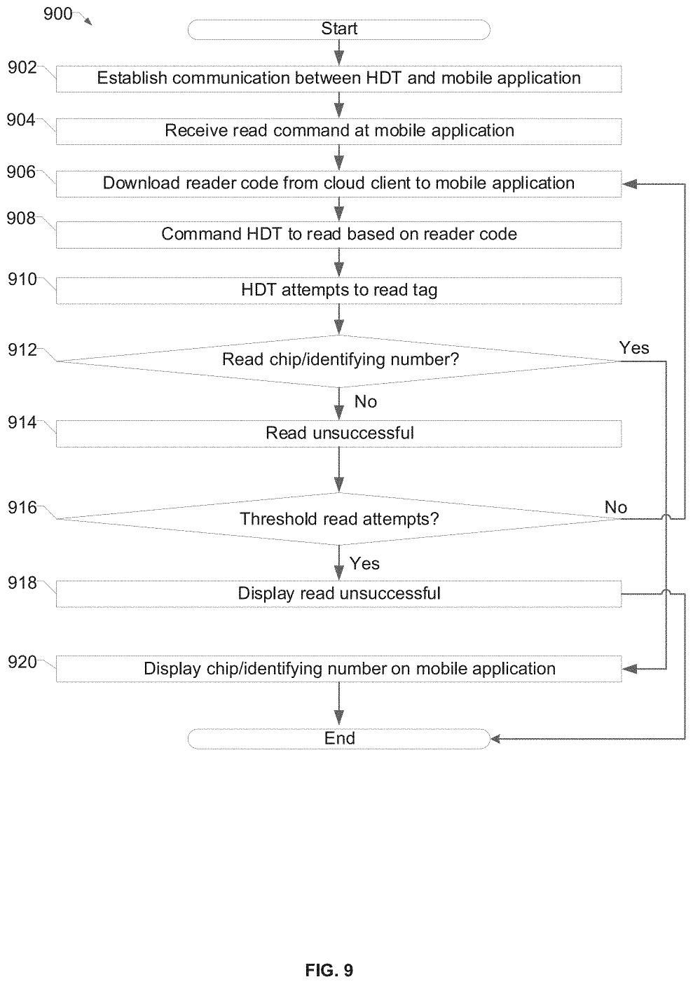

FIG. 7 illustrates an example exploded view of the HDT 102 as illustrated and described in FIGS. 2-6. As illustrated, the battery 118 may be adhered to the case back 206 via an adhesive. The case back 206 may engage with and secured to the case front 204 via corresponding engagement pins 220 and 222.

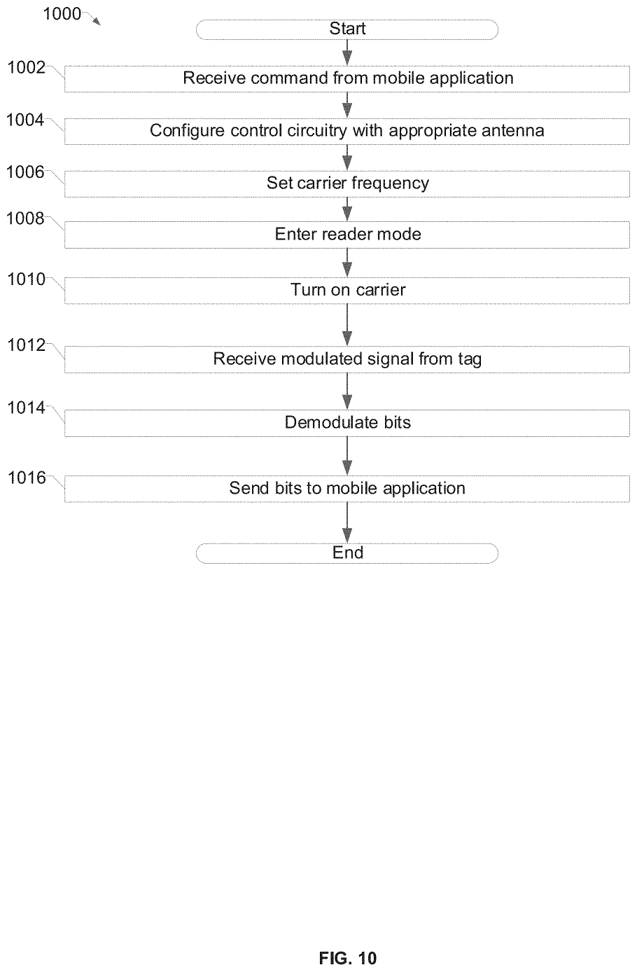

FIG. 8 is a block diagram of an example radio frequency identification reader and emulator system, for example the system 100 of FIG. 1. As described with reference to FIG. 1, the system 100 includes an HDT 102, a mobile application 120, and cloud infrastructure 124. Cloud infrastructure 124 may include a server 802. The server 802 may host an application programming interface (API) 804 and include a database 806 for storing data. A mobile application 120 may communicate with the API 804, and thus transmit data to and receive data from the client 808 and database 806 via the API 804.

The server 802 may also host a reader and emulator client 808 (the “client”). The server may also have memory 810 which may store images and files for the client. The client 808 may host and/or run software, for example open source Proxmark3 software, which may read and emulate various RFID tags. See, for example https://github.com/Proxmark/proxmark3 and http://www.proxmark.org/files/.

For example, the memory 810 may include executable code to read various types of RFID tags. When an operator initiates a read command via a mobile application 120, the mobile application 120 may send a request to the API 804. The API 804 may then grab the appropriate reader executable code from the client 808, which retrieved the appropriate executable code from memory 810. The API 804 then may return the executable code to the mobile application 120, which may forward the executable code to the HDT 102. The HDT 102 may then use that executable code to read the RFID tag. In some examples, the client 808 may be hosted on a second server (not shown), which the API 804 may connect to and communicate with via a virtual port.

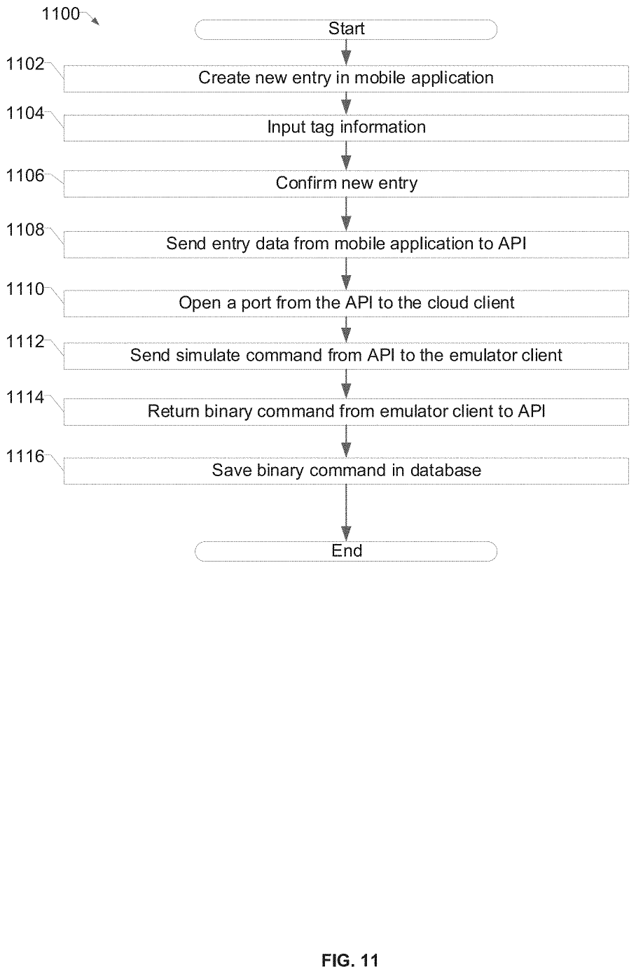

FIG. 9 shows a flowchart of an example method 900 of reading an RFID tag using the RFID reader and emulation system 100 of FIGS. 1 and 8 and the HDT 102 of FIGS. 1-8. At block 902, communication is established between the HDT 102 and a mobile application 120, for example via a Bluetooth connection via the Bluetooth interface 112 or USB 114. For example, an operator may press a button 208 to wake the HDT 102 from a low-power mode and establish communication with a mobile application 120. At block 904, the operator enters a read command via the mobile application 120. When entering a read command, in some examples, the operator may also input specific information about the RFID tag to be read, such as the tag frequency range, tag manufacturer (e.g., HID), or tag type. In some examples, such tag information may be displayed on the tag. For example, an access badge may show that it is an “HID” tag with a series of identifying numbers. In some examples, an operator may take a picture of the RFID tag to be read with the camera 128, and the mobile application 120 or a program in the API 804 may automatically detect the tag type and/or other information about the RFID tag to be read. In some examples, the operator may not input any tag information because the tag information can be accessed by pulling tag information directly from an administrative system or access controller system that the operator has been assigned a badge from. In some examples, the tag information may be created by the HDT 102 to be learned by a reader.

At block 906, the mobile application 120 downloads executable code to read the RFID tag. For example, the mobile application may send a request to the API 804 including tag type. The API 804 then retrieves from the client 808 the appropriate executable code to read that tag type and sends that retrieved executable code to the mobile application 120. In some examples, the API 804 only retrieves from the client 808 a portion of the appropriate executable code, i.e. the executable code to read a subset of the selected tag types, to limit the total download. If that portion does not successfully read the RFID tag, then as discussed in more detail below, the API 804 may retrieve the next portion of the appropriate executable code. The system 100 may repeat this process until the RFID tag is successfully read, or until all of the appropriate executable code has been run, but there was no successful read, indicating a problem with the RFID tag. In some examples, the operator may not input a tag type or any other discriminating tag information (e.g., manufacturer, issuer, or operating frequency). In such examples, the system 100 may iteratively run portions of the reader executable code until the RFID tag is successfully read or until all of the reader executable code has been run without a successful read.

At block 908, the mobile application sends a read command to the HDT via the Bluetooth interface 112 or USB 114 based on the reader executable code downloaded from the cloud client 808 via the Bluetooth interface 112 or USB 114. At block 910, the HDT 102 attempts to read the tag based on the received read command from the mobile application 120. At block 912, the HDT 102 returns read bits to the mobile application 120 and the mobile application 120 determines whether the chip/identifying number of the RFID tag has been successfully read using the reader code. If the chip/identifying number was not successfully read (block 912) then at block 914 the mobile application 120 determines that the read operation was unsuccessful. Then at block 916 the mobile application 120 checks if a threshold number of read attempts have been run, (i.e., whether all of the appropriate reader executable code been run). If a threshold number of read attempts have been run (block 916), then at block 918, the mobile application 120 displays to the operator that the read was unsuccessful. If the threshold number of read attempts was not reached, (i.e., there is more reader executable code to be run), then the process returns to block 906, and the mobile application 120 downloads the next portion of the reader executable code and repeats block 906-912.

Returning to block 912, if the HDT 102 successfully read the chip/identifying number of the tag, then at block 920 the mobile application 120 displays the chip/identifying number.

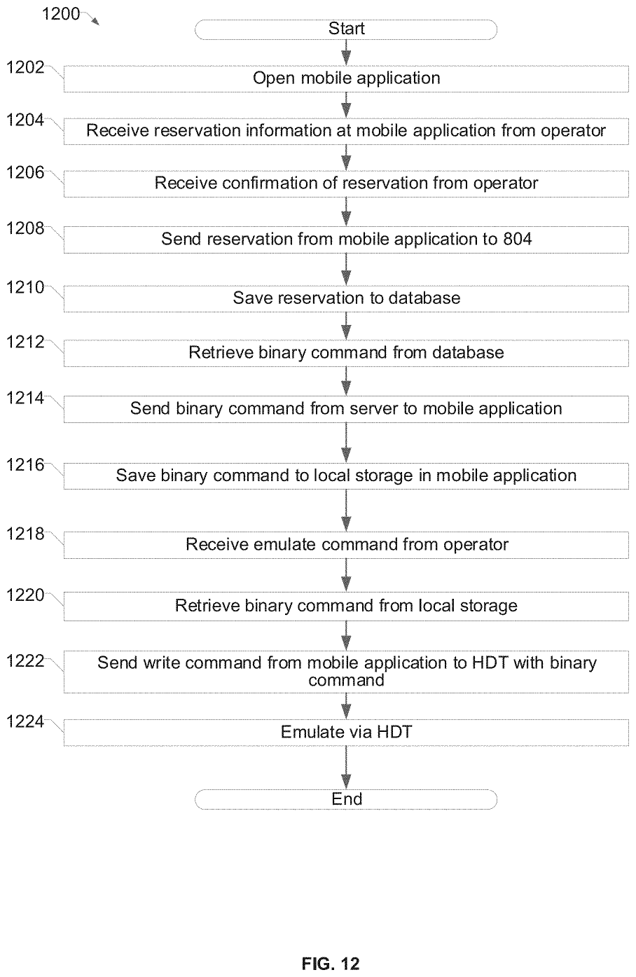

FIG. 10 shows a flowchart of an example method 1000 of reading an RFID tag using the HDT 102. Example method 1000 may correspond to blocks 908-912 of example method 900 of FIG. 9.

At block 1002, the control circuitry 110 of the HDT 102 receives a read command from a mobile application 120 via the Bluetooth interface 112 or USB 114. The command may include a carrier frequency setting. The control circuitry 110 may include a processor and a field-programmable FPGA. In some examples, one FPGA may operate with both the HF circuitry 104 and LF circuitry 106, and only requires a configuration change to switch between working with the HF circuitry 104 and the LF circuitry 106. The UHF circuitry 108 may be driven directly by the processor and the UHF circuitry 108. In some examples the LF, HF or UHF circuitry may only be driven by a processor in control circuitry 110 with a Bluetooth interface 112 built in.

At block 1004, the control circuitry 110 is configured to work at the commanded frequency. For example, the processor may command the FPGA be configured work with the HF circuitry 104 or the LF circuitry 106.

At block 1006, the carrier frequency at which to transmit, and thereby read, is set in the control circuitry 110 (i.e., the FPGA). At block 1008, the HDT 102 enters reader mode, and at block 1010 the HDT turns on the carrier to transmit a reader signal from the selected antenna (LF, HF, or UHF). At block 1012, the HDT 102 receives a modulated backscatter signal back from the RFID tag via the selected antenna.

At block 1014, the control circuitry 110 demodulates the modulated backscatter signal to a series of bits. For example, the envelope of the received signal from the antennas may be detected using analog circuitry on the board and then the envelope signal may be decoded by the FPGA (collectively included in control circuitry 110 of FIG. 1). Accordingly, the FPGA may be configured as an edge detector to delineate bit periods, control automatic gain adjustment, and frame the detected bits to provide to the processor (of the control circuitry 110) for further decoding. Collectively the demodulation step 1014 includes performing the envelope detection, data/bit timing recovery, and demodulation of the signal received from the antenna such that a raw unmodulated series of bits can be obtained. In some examples, the FPGA may also be configured to detect the envelope of the received signal using digital signal processing and an analog to digital converter (i.e. rather than analog circuitry detecting the envelope.) For descriptions of envelope detectors, see J. D. Griffin and G. D. Durgin, “Link Envelope Correlation in the Backscatter Channel,” IEEE Communication Letters, vol. 11, no. 9. The entirety of “Link Envelope Correlation in the Backscatter Channel,” is incorporated by reference. Also see U.S. Published Patent Application No. 2015/0136857 by Nicolas Pillin, et. al, filed Nov. 6, 2014 titled “Envelope detector circuit.” The entirety of U.S. Published Patent Application No. 2015/0136857 is incorporated by reference. Also see U.S. Pat. No. 7.689,195 by Jiangfeng Wu and Donald Edward Major, filed Jun. 16, 2005, titled Multi-protocol radio frequency identification transponder transceiver. The entirety of U.S. Pat. No. 7,689,195 is incorporated by reference.

At block 1016, the control circuitry 110 may then transmit the bit string to the mobile application 120 via the Bluetooth interface 112 or USB 114.

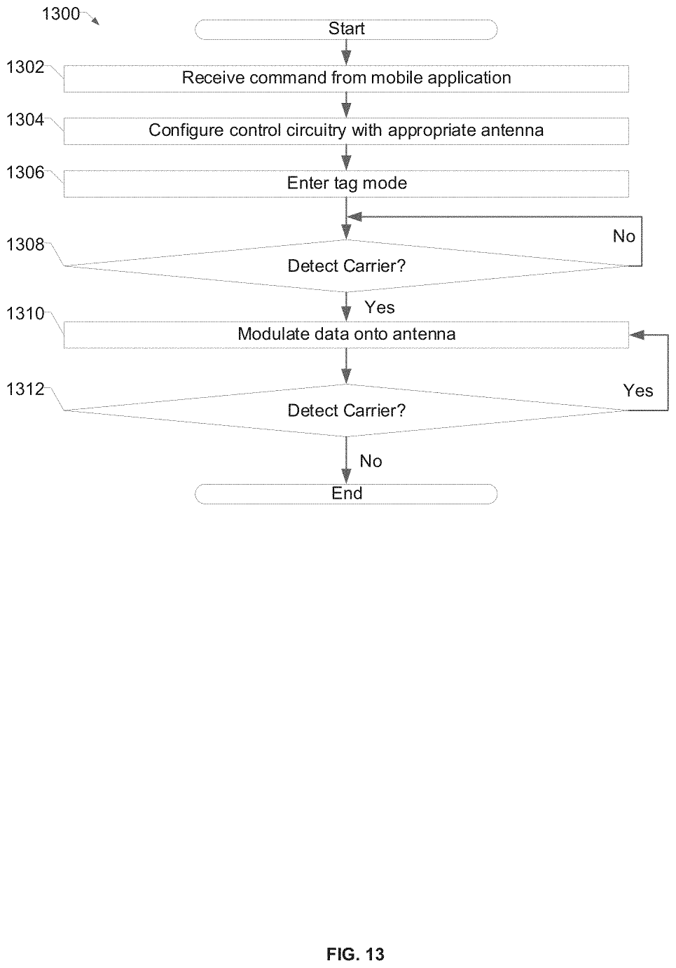

FIG. 11 shows an example method 1100 in which RFID tag information may be saved into an operator account in cloud infrastructure 124 for either later use or to share with other operators.

At block 1102, the operator creates a new entry in a mobile application 120. In some examples, an operator may create the entry in a web application, for example a web application running on a desktop computer, a laptop computer, a tablet computer, or a mobile phone. The entry may include information such as a specific parking garage or lot to which the RFID tag may provide access, or a specific office building to which the RFID tag may provide access.

At block 1104, RFID tag information is input into the entry. In some examples, RFID tag information (i.e., a serial code and a tag type) is read from a physical RFID tag via an HDT 102, for example using the method 900 of FIG. 9 and then loaded into the entry at block 1104. In some examples, an operator may enter in the tag information, for example by manually typing in the information and/or selecting a tag type, for example via a drop down list. At block 1106, the operator confirms the new entry. After the operator confirms the new entry (block 1106), at block 1108, the mobile or web application 120 sends the entry data to an API 804 in the cloud infrastructure 124. At block 1110, the API 804 opens a port to the client 808. At block 1112, the API 804 sends a simulate command to the client 808. The simulate command includes the tag type information and serial code input at block 1104. At block 1114, the client returns a binary command to the API 804. The binary command is created based on the input tag type and the chip/identifying number. The binary command can be used by an HDT 102 to emulate the RFID tag having the input tag type and chip/identifying number. In some examples, the HDT 102 may be able store the client 808 in the control circuity 110 to eliminate the need for the API 804 to transfer a binary commend but instead just provide the tag type and chip/identifying number.

At block 1116, the API stores the binary command in the database 806. The binary command may be stored in the database 806 in an entry along with the rest of the entry information input by the operator at blocks 1102-1104. The entry in the database 806 may also be keyed to the operator's account. For example, an account may be keyed to a telephone number, and the database entry also stores the telephone number of the mobile phone running the mobile application 120 on which the entry was created. In some examples, the database 806 may store the tag type and chip/identifying number in their original form.

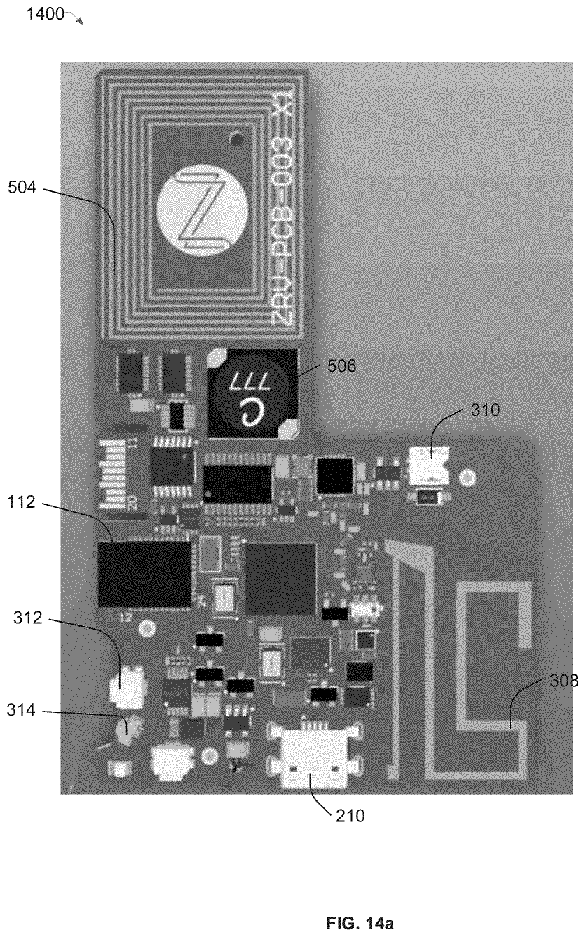

FIG. 12 shows an example method 1200 of emulating a radio frequency identification tag using a radio frequency identification reader and emulator.

At block 1202, an operator opens a mobile application 120. At block 1204, the operator creates a reservation which requires an RFID tag to access. For example, an operator may create a reservation for a specific parking lot or for a specific hotel room. In some examples, the reservation may include a block of time, i.e. a time period during which the emulation will work. At block 1206, the operator confirms the reservation.

After the operator confirms the reservation (block 1206), at block 1208 the mobile application sends the reservation to the API 804. At block 1210, the API 804 saves the reservation to the database 806 and determines the necessary RFID tag information that corresponds to the reservation (e.g., the RFID tag information that provides access to a door or garage). At block 1212, the API 804 retrieves the binary command from the database 806 corresponding to the reservation. At block 1214, the binary command is sent from the API 804 to the mobile application 120. At block 1216, the mobile application saves the binary command in memory 126. In some examples, the binary command may be the tag type and chip/identifying number in their original form. In some examples, the binary command may be saved in the local memory 111 of the HDT 102 processor. In some examples, the binary command is not saved in the mobile application memory 126 or the HDT 102 processor but passed from the server 802, through the mobile application 120, and used by the HDT 102 immediately, without being saved. In some examples, the binary command can be saved on the HDT 102, the mobile application 120 and the server 802. In some examples, the API 804 also sends a command to the mobile application 120 to only allow the binary command to be run during a reserved time period or set number of uses. In such examples, an operator may only emulate an RFID tag using the binary command during the reserved time period or number of uses, for security or other reasons.

When an operator is ready to emulate an RFID tag, for example when an operator needs to access a garage or door, at block 1218, the operator enters an emulate command into the mobile application 120. At block 1220, the mobile application 120 may retrieve the binary command from memory 126. At block 1222, the mobile application 120 sends an emulate command to the HDT 102 via the Bluetooth interface 112 or USB 114. At block 1224, the HDT 102 emulates the RFID tag via running the received binary command. In some examples, the operator might not need to initiate the emulation command through the mobile application 120 because the mobile application 120 might be able to initiate the command by itself, for example when it identifies it is in proximity of the HDT 102.

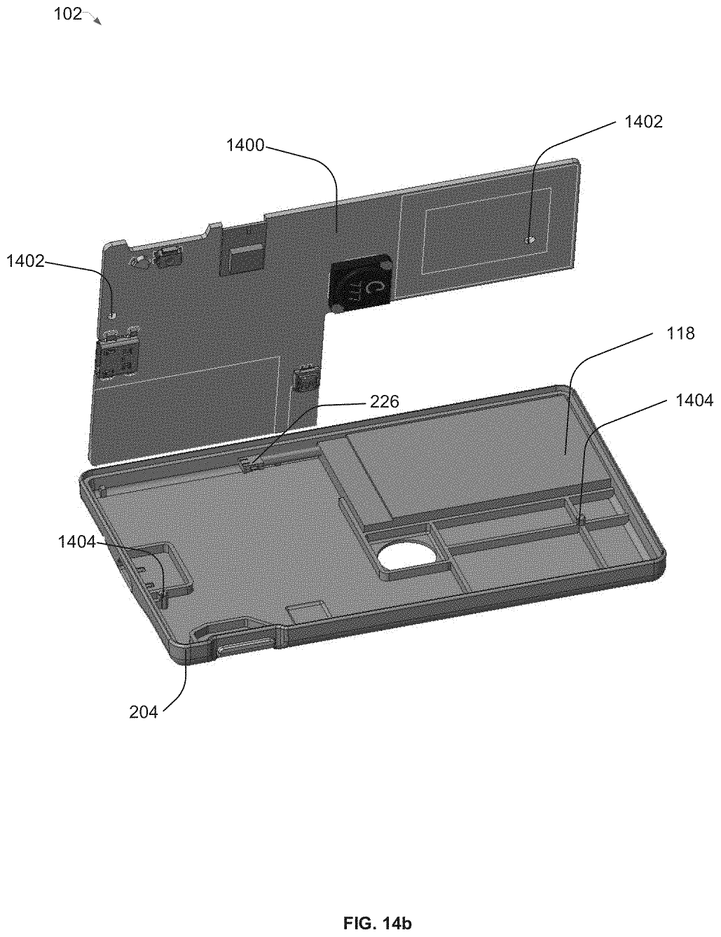

FIG. 13 shows an example method 1300 that may be used to implement the emulate process of block 1224 of method 1200 of FIG. 12.

At block 1302, the control circuitry 110 of the HDT 102 receives an emulate command from a mobile application 120 via the Bluetooth interface 112 or USB 114. The emulate command includes a binary command. The control circuitry 110 may include a processor and a field-programmable gate array (“FPGA”). In some examples, one FPGA may operate with both the HF circuitry 104 and LF circuitry 106, and only requires a configuration change to switch between working with the HF circuitry 104 and the LF circuitry 106. In some examples, the HF circuitry 104 and the LF circuitry 106 may be driven directly by the processor in the control circuity 110 and the HF circuitry 104 and the LF circuitry 106. The UHF circuitry 108 may be driven directly by the processor and the UHF circuitry 108.

At block 1304, the control circuitry 110 is configured to work at the commanded frequency. For example, the processor may command the FPGA be configured work with the HF circuitry 104 or the LF circuitry 106. At block 1306, the control circuitry 110 enters into tag (i.e., emulate) mode, where the HDT 102 operates as an RFID tag which can be read by an RFID reader.

At block 1308, the control circuitry 110 waits to detect a carrier signal from an RFID reader. Once a carrier signal is detected, at block 1310, the control circuitry 110 modulates the data sent to the HDT 102 in the binary command. Modulation is accomplished by modulating the load on the antenna at the correct rate and level to transmit the tag data in the binary command to the RFID reader through backscatter modulation of the carrier signal transmitted from the RFID reader to the HDT 102. Upon successful reading of the tag information from the HDT 102, the RFID reader recognizes the emulated tag. When this occurs, for example access to a door or garage may be granted.

At block 1312, the control circuitry 110 continues to detect for a carrier signal. If a carrier signal is detected, the control circuitry 110 continues to modulate the data onto the antenna at block 1310. If a carrier is no longer detected (1312), the emulation process ends. In some examples, the HDT 102 may stop modulating the data onto the antenna because it is instructed to stop by the control circuitry 110 or by the mobile application 120.

Returning to FIGS. 1-8, the system 100 which includes a universal RFID device such as the HDT 102 that may read various types of RFID tags, upload tag information to a cloud database, and retrieve tag information stored in a database in order to emulate any RFID tag, may have myriad applications.

For example, in the hotel industry, a hotel may maintain a database with serial codes of RFID tags that provide access to hotel rooms, which may be hosted in the cloud infrastructure 124 of FIGS. 1 and 8. Each hotel room door may have a reader, and the hotel room door key may be a RFID tag. Rather than waiting to check in and check out, a hotel visitor may download a room access code via a mobile application and may then emulate the serial code to gain access to the hotel room via an HDT as described in this disclosure. In some examples, the hotel may change the access codes to limit the date and time when the serial code will provide access to the hotel room. In other examples, a mobile application may include code which only allows the emulator to emulate the tag within the allowed time period or number of uses.

Similarly, in home sharing, homeowners may provide access to keys, for example keys in a radio frequency lockboxes via granting a temporary access serial code or temporary access to the serial code to a renter. In some examples, the home may have an RFID unlocking door knob. The renter may then download the access serial code and unlock the lockbox or door knob via emulating an RFID tag having the access serial code with a mobile application and an HDT as described in this disclosure. A mobile application 120 may keep a record of when a serial code was used to unlock the lockbox or door, which may then be transmitted to and saved in a database 806 hosted in the cloud infrastructure 124, in order to record the renters who were within the home as well as when the renters accessed the home. Similarly, homeowners may grant access to a lockbox containing keys to a home to realtors or perspective buyers via granting a temporary access serial code or temporary access to the serial code to the realtor or perspective buyer. The realtor or perspective buyer may then access the keys in the lockbox via downloading the access serial code and emulating the serial code with an HDT and a mobile application. A mobile application 120 may keep a record of when a serial code was used to unlock the lockbox, which may then be transmitted to and saved in a database 806 hosted in the cloud infrastructure 124, in order to record the renters who were within the home as well as when the renters accessed the home.

Similarly in parking application, a parking garage or parking lot may allow temporary access to a driver by granting a temporary access serial code or granting temporary access to the serial code to the driver. The driver may download the access serial code and emulate the serial code with an HDT and a mobile application to gain access to the garage or lot. In some examples, temporary access serial code may be or may become permanent.

Commercial and residential buildings, private clubs, and offices may similarly grant access to the building, club, or office to a full-time tenant or visitor via granting an access serial code or temporary access to the serial code to the visitor. Additionally, the building, club, or office might give provide all members access to a mobile application 120 and a HDT 102 to replace RFID tags for security and convenience. A user may download the access serial code and emulate the serial code using an HDT 102 and a mobile application 120 to gain access to the building, club, or office. Using such a system may allow buildings, clubs, and offices to allow access to full-time tenant or visitors without requiring them to check in at front desks. A mobile application 120 may keep a record of when a serial code was used to access the building, club, or office, which may then be transmitted to and saved in a database 806 hosted in the cloud infrastructure 124, in order to record the full-time tenant or visitors who were within the building, club, or office as well as when the full-time tenant or visitors accessed the building, club, or office. Such a system may also be used for food and/or package delivery services, as delivery persons may gain access to a building, club, or office via emulating an RFID access serial code.

Disclosed universal RFID readers may also be used in inventory tracking. Inventory may be tagged with RFID tags. Manufacturers or issuers of different items in inventory may use various types of RFID tags, necessitating the use of multiple RFID readers. The described universal RFID device and system may read various RFID tags, thus eliminating the need for multiple RFID readers.

Disclosed universal RFID emulators may also be used to pay highway toll passes. Thus a user may pay for toll roads without a RFID toll device by emulating the RFID toll device with the universal RFID emulator. The universal RFID emulator may emulate any RFID toll device, thus eliminating the need for multiple toll devices.

Disclosed universal RFID emulators may also be used as a payment system. Credit cards may have RFID tags which are read by RFID readers to complete a transaction. A universal RFID emulator may emulate the RFID tag within a credit card to.

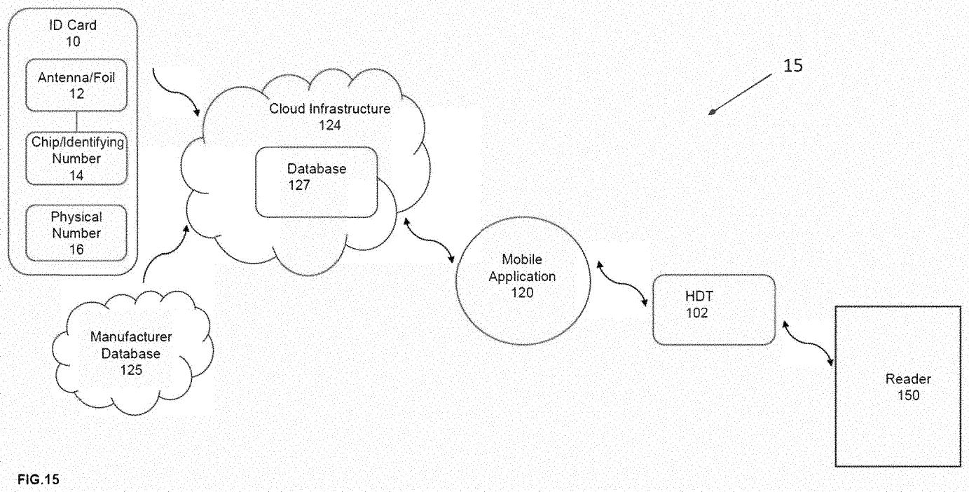

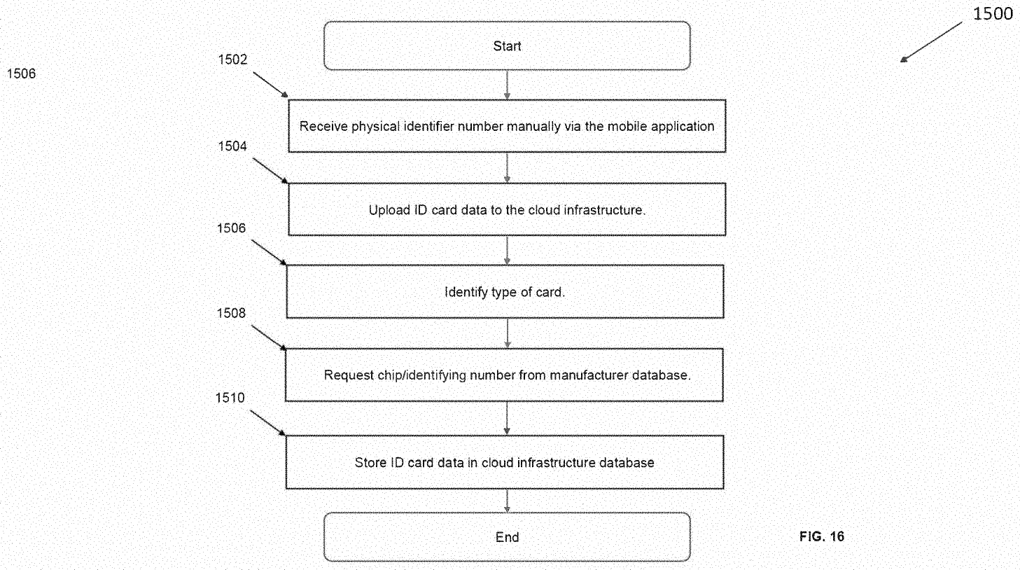

FIG. 14a illustrates an example circuit board 1400 which may be used in an HDT 102 to as an alternative to the antenna board 502 and the circuit board 302 as described with reference to FIGS. 3a, 3b, and 5. The circuit board 1400 includes an HF antenna 504, an LF antenna 506, a UHF antenna 308, a USB port 210, a battery connector 310, a Bluetooth interface 112, a switch 312 and an indicator light 314. The circuit board 1400 generally functions in the same way as the circuit board 302 and antenna board 502 as described with reference to FIGS. 3a, 3b, and 5, however the antennas (HF 504, LF 506, and UHF 308) are configured to fit onto the main circuit board 1400. For example, the LF antenna 506 of FIG. 14 may be a smaller antenna than the LF antenna 504 as depicted in FIG. 5. The UHF antenna 308 may also operate at frequencies ranging from 860 to 960 MHz.

FIG. 14b illustrates the circuit board 1400 and the front cover 204 of the HDT 102. A battery 118 is attached to the inside of the front cover 204, for example via an adhesive. The battery 118 is electrically connected to a battery connector 226, which connects to the circuit board 1400 via the battery connector 310 of the circuit board 1400. The circuit board 1400 includes apertures 1402 which receive ribs 1404 on the front cover 204 which hold the circuit board 1400 in place within the HDT 102. Including the antennas (HF 504, LF 506, and UHF 308) on the circuit board 1400 as described with reference to FIGS. 14a and 14b allows for the of the HDT 102 to physically thinner as compared to a HDT 102 which includes a separate antenna board 502 and circuit board 302, as described with reference to FIGS. 3a, 3b, and 5.

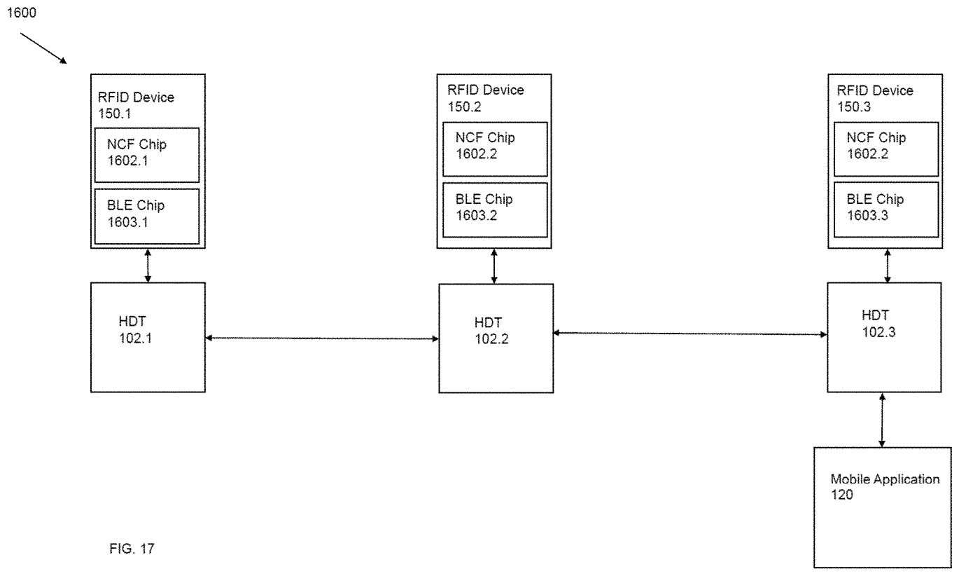

FIG. 15 is a block diagram of an example system 15 for emulating a physical proximity identification card 10. A physical proximity identification card 10 includes an RFID tag which is readable by an RFID reader 150, for example a badge reader. Cards 10 are typically assigned to individual persons and given specific access rights. For example user John Smith may be issued a specific card 10. The card 10 issued to user John Smith may be, for example, provisioned to access specific access points (e.g. the turnstile in the lobby, elevator access to the 11^{th} floor, and door access on the 11^{th} floor).

In some examples, these cards 10 may be physically identified by a physical number 16 that is printed on the card 10. This number 16 may be used for plain text identification, meaning that if an everyday user is asked to provide their proximity ID card number, this physical number 16 might be the number they would provide. However, this possible physical number 16, may provide a digital lookup. The digital lookup is referred to as using the physical identifier 16 to find out the chip/identifying number 14. In some examples, the chip/identifying number 14 may be the identifier that the card 10 communicates over radio frequency to the reader 150. The way this may be done is that the card's antenna 12 or foil 12, picks up the radio waves being sent out by the access reader 150, directs the energy to the circuity of the card 10, which provides the chip/identifying number 14 for that card 10, and transmits the chip/identifying number 14 back to the reader 150. In some example, the physically identifier could be a picture, and/or a logo, and/or an address, and/or a names, and/or any identify mark other than a blank front and back card.

In the system of FIG. 15, information from a physical proximity identification card 10 that is read by an RFID badge reader 150 (e.g., to gain access to a building, floor, garage, etc.) may be digitally recorded and organized in a database 127 that may be stored in the cloud infrastructure 124. A mobile application 120 may pull the recorded information from the cloud database 127 when the HDT 102 is used to digitally emulate the physical proximity identification card 10. In some examples, the database 127 may be stored a local infrastructure (i.e. a local computer) that is not stored in a cloud infrastructure 124.

In some examples, manufacturers or issuers of a physical proximity identification cards 10 may create and maintain their own databases 125 which may store and associate unique physical numbers 16 printed on the card(s) 10 with identifying numbers 14 stored in the cards 10. As described above and in some examples, the chip/identifying number 14 is read by the badge reader(s) 150 and is used to grant access. The information from a manufacturer or issuer database 125 may further be stored in a separate database 127 stored on the cloud infrastructure 124 which organizes the information from the manufacturer or issuer database 125 such that a specific card 10 having a specific physical number 16 and a specific chip/identifying number 14 may be associated with a specific location (e.g., associated with one or more specific badge readers 150 which read the specific card 10 and grant access to the holder of the card 10). The database 127 may also associate specific users with specific cards 10. In some examples, the manufacturer or issuer database 125 may be stored a local infrastructure (i.e. a local computer) that is not stored in a cloud infrastructure 124.

The mobile application 120 may be provided in a Software Development Kit (SDK) format or in an Application Program Interface (API) or the mobile application 120 may be developed with preset integration guidelines which outline how the cloud infrastructure 124 retrieve and store information to the cloud database 127 coming from a physical proximity identification card 10. The mobile application 120 and the cloud infrastructure 124 communicates information between the cloud database 127 and the HDT 102. For example, as described above, the mobile application 120 communicates read and emulation data between the cloud infrastructure 124 and the HDT. The mobile application 120 may also be used to input the physical chip/identifying number 16 associated with the card 10, the physical chip/identifying number 16 may then be uploaded to the cloud infrastructure 124 and stored in the cloud database 127. In some examples, the physical chip/identifying number 16 may be input into the mobile application 120 by a user manually. In some examples, a user may take a picture or scan the physical number 16 on the card 10 with a camera 128 of the device running the mobile application 120, and the mobile application 120 may be able recognize the text of the number 16 in the picture or scan.

The connection from a mobile application 120 to the HDT 102 is made through a Bluetooth connection (or the like). When a user utilizes a mobile application 120 to request access to a specific location (e.g., a building, floor, garage, etc.), the mobile application 120 requests data from the cloud infrastructure 124 in order to emulate the physical card 10 which would be used to access that specific location over an internet connection. Through the mobile application 120, the webservice may already have information regarding the specific individual and location where access is requested. For example, the mobile application 120 may be linked to a user account, and the mobile application may have access to the location services of the device which is running the mobile application 120 (e.g., a GPS of a smartphone). The cloud infrastructure 124 returns the data necessary to emulate the physical card 10 from the database 127 to the mobile application 120. In some examples, if the digital data associated with the specific card 10 to be emulated is not already stored in the cloud database 127, the cloud infrastructure 124 requests the digital data (i.e., the chip/identifying number 14) required to emulate the card 10 from the manufacturer or issuer database 125 based on the unique physical number 16 associated with the card 10. The mobile application 120 then transfers this data to the HDT 102 over a Bluetooth connection (or the like). The HDT 102 uses this data to emulate the physical card 10 and achieve access via the badge reader 150.

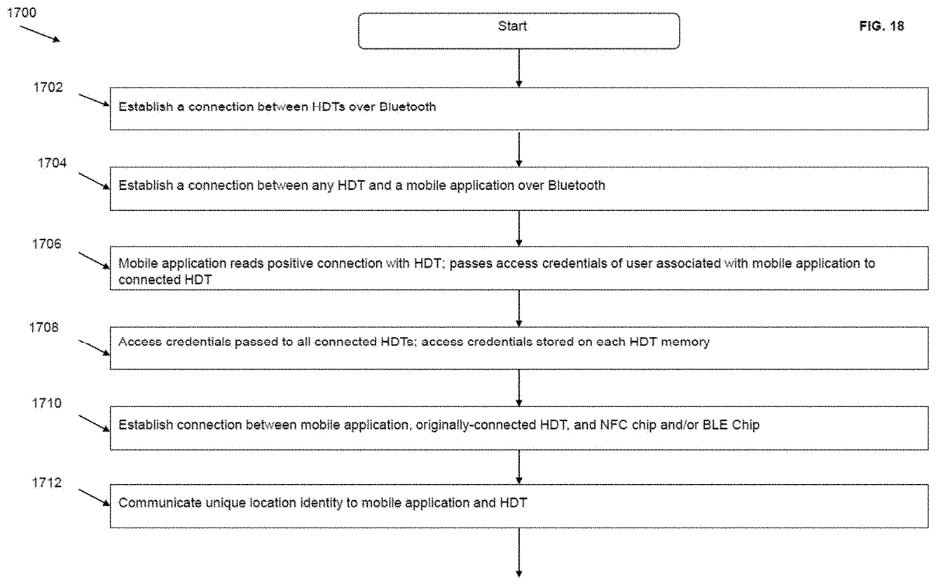

FIG. 16 illustrates an example method 1500 in which information from a physical proximity identification card 10 is stored in the cloud database 127 for use in later emulation. The method 1500 may execute by the system 15 of FIG. 15. At block 1502, the mobile application 120 receives the physical identifier number 16 associated with an card 10. For example, a user may input the number 16 manually. In some examples, a user may take a picture of the card 10 or scan the card 10, and the mobile application 120 may recognize the text of the physical number 16 in the picture or scan. At block 1504, the mobile application 120 communicate that information to the cloud infrastructure 124, for example via webservices over an internet connection. At block 1506, the cloud infrastructure identifies the card 10 type (e.g., the manufacturer or issuer of the card 10). In some examples, the cloud infrastructure identifies the card type 10 based on the received physical number 16. For example, the physical number may include a string of numbers that identifies the card 10 type. In some examples, a user may manually input the card type into the mobile application 120, and that input is also uploaded to the cloud infrastructure 124. In some examples, the mobile application 120 or the cloud infrastructure 124 identifies the card 10 type based on the picture or scan of the card which was also used to identify the physical number 16.

At block 1508, the cloud infrastructure 124 requests the chip/identifying number 14 from the manufacturer or issuer database 125. The cloud infrastructure 124 requests the chip/identifying number 14 from the manufacturer or issuer database 125 of the specific manufacturer or issuer identified in block 1506. The request for the chip/identifying number 14 includes the physical identifier number 16 which the cloud infrastructure 124 received at block 1504. At block 1510, the cloud infrastructure 124 stores the received card 10 chip/identifying number 14, physical number 16, and associated user into the database 127. In some examples, the associated user may be determined based on the user account which uploaded the physical identifier number 16 in block 1504. In some examples, the associated user is manually input into the mobile application 120 and is sent along with the physical identifier number 16 data in block 1504.

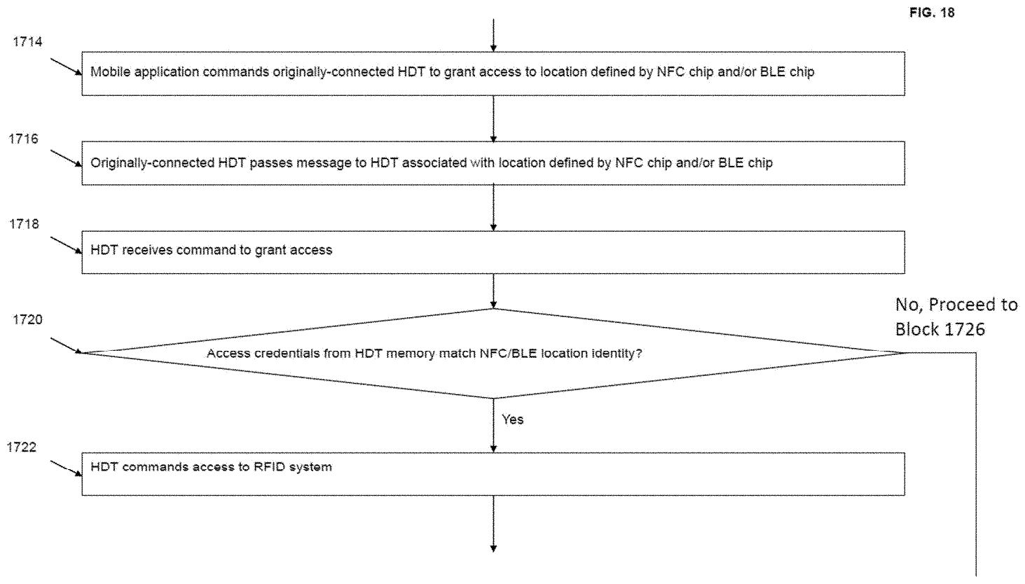

FIG. 17 is a block diagram of an example access system 1600 that utilizes Bluetooth and one or more RFID emulator(s) and reader(s). In the example access system 1600, access may be granted to a location via one or more RFID reader(s) (150.1, 150.2, 150.3) which are within close proximity. A common example of this scenario is where there are multiple turnstiles in an office location. In some examples, a single RFID reader 150.1 which grants access to a location may be associated with a single HDT 102.1 (e.g., a single reader may provide access to a single door or turnstile). In the system 1600, each access reader (150.1, 150.2, 150.3) has an associated individual HDT (102.1, 102.2, and 102.3). The HDTs 102.1 102.2, and 102.3 may operate as described with respect to FIGS. 1-16 above. In the illustrated example of FIG. 17, HDT 102.1 is installed with the reader 150.1, HDT 102.2 is installed with the reader 150.2, and HDT 102.3 is installed with the reader 150.3. In some examples, the HDTs 102.1 102.2, and 102.3 connect with each other over Bluetooth, creating a mesh network which enables the HDTs 102.1 102.2, and 102.3 to communicate and share information across HDTs (102.1 102.2, and 102.3). In some examples, the HDTs 102.1 102.2, and 102.3 do not connect with each other over Bluetooth, but instead say independent and do not share information across HDTs (102.1 102.2, and 102.3).

In the system 1600, a user can access the location by running a mobile application 120 on a mobile device. For example, a user account associated with the mobile application may be granted access to the location which is guarded by the access point readers (150.1, 150.2, 150.3). The cloud infrastructure 124 provides the data to the mobile application 120 to emulate a badge associated with the particular user. The mobile application 120 forwards that data, via Bluetooth (or any other suitable wireless communication protocol (e.g., NFC, WIFI, Ultra WideBand)), to the HDT (102.1 102.2, 102.3) associated with the access point (150.1, 150.2, 150.3) to which the user holding the device running the mobile application 120 is located physically closest to. Accordingly, the mobile application120 may continuously scan for and connect to HDTs via Bluetooth ((or any other suitable wireless communication protocol (e.g., NFC, WIFI, Ultra WideBand)) when in an emulation/access mode. The HDT (102.1 102.2, 102.3) then emulates the chip/identifying number of the card 10 associated with the user and the user is granted access without carrying a physical card 10 or a personal HDT 102.

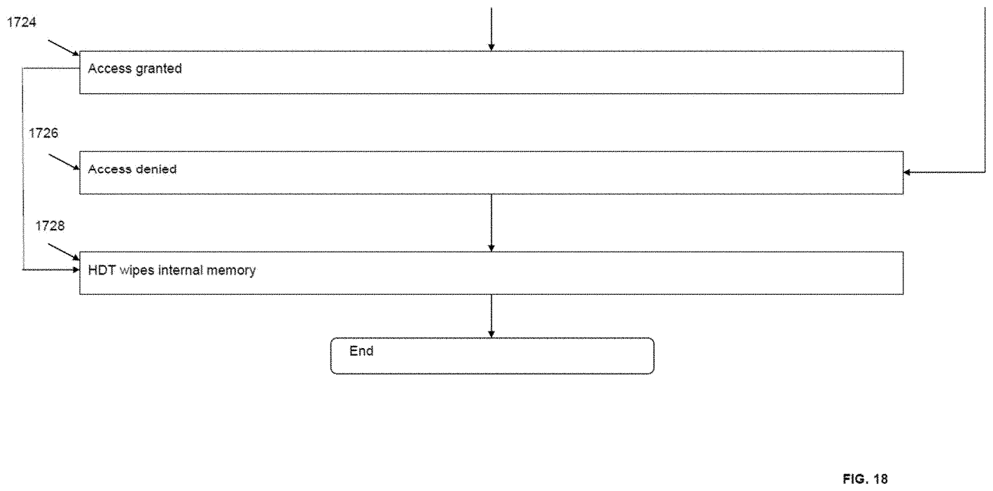

FIG. 18 is a flowchart of an example method 1700 in which a user can achieve access to a location via a mobile application 120 which connects to an HDT (102.1 102.2, 102.3) connected to a access RFID reader (150.1, 150.2, 150.3). At block 1702, the HDTs (102.1 102.2, 102.3) connect to each other via Bluetooth. The HDTs (102.1 102.2, 102.3) create a mesh network, allowing the HDTs (102.1 102.2, 102.3) to communicate and share information across devices. In some examples, the HDTs (102.1 102.2, 102.3) are not connected to each other via Bluetooth to share information. In some examples, the HDTs (102.1 102.2, 102.3) could be removed and a mobile application could communicate with an access RFID reader (150.1, 150.2, 150.3).

In the example method 1700, at block 1704, the user first establishes a connection to HDT 102.3. The method 1700 is the same if the user connects to HDT 102.1 or HDT 102.2. The HDT (102.1 102.2, 102.3) to which the mobile application 120 connects is typically the HDT (102.1 102.2, 102.3) which is physically closest to or has the strongest connection to the device on which the mobile application 120 is running. The mobile application 120 connects to the HDT 102.3 via Bluetooth (or any other suitable wireless communication protocol (e.g., NFC, WIFI, Ultra WideBand)). After the user connects to the HDT 102.3, at block 1706, the mobile application 120 passes information from the cloud infrastructure 124 to the HDT 102.3. The HDT 102.3 can use this information to emulate an card 10. Once the HDT 102.3 receives the information from the cloud infrastructure 124, at block 1708, the HDT 102.3 shares the received information with the other HDTs (102.1 and 102.2) which it connected to in block 1702. Each HDT (102.1 102.2, 102.3) will store the information received from the mobile application 120 in its internal memory 111 for a predetermined amount of time.

In some examples, each RFID reader (150.1, 150.2, 150.3) has an associated a NFC chip 1602 assigned to it. In some examples, each RFID reader (150.1, 150.2, 150.3) has an associated a Bluetooth (e.g., Bluetooth low energy (BLE)) chip 1603 assigned to it. In some examples, each RFID reader (150.1, 150.2, 150.3) has an associated NFC chip 1602 and BLE chip 1603. When there are multiple potential access readers (150.1, 150.2, 150.3 within a very close proximity, each reader (150.1, 150.2, 150.3) has an individual associated passive NFC chip (1602.1, 1602.2, 1602.3) and/or BLE chip (1603.1, 1603.2, 1603.3). Some mobile devices may only have one of either NFC or BLE capabilities, so the RFID device may have both an NFC 1602 and a BLE chip 1603 to facilitate communications with more mobile devices. In this example, NFC chip 1602.1 is associated with reader 150.1, NFC chip 1602.2 is associated with reader 150.2, and NFC chip 1602.3 is associated with reader 150.3. BLE chip 1603.1 is associated with reader 150.1, BLE chip 1603.2 is associated with reader 150.2, and BLE chip 1603.3 is associated with reader 150.3. Each NFC chip (1602.1, 1602.2, 1602.3) and/or BLE chip (1603.1, 1603.2, 1603.3) is programmed with a unique location identity. At block 1710, when an end user places their mobile device running the mobile application 120 within a close proximity of the reader 150.1 (e.g, touches the mobile device to the reader 150.1), the unique location identity from the NFC chip 1602.1 (or BLE chip 1603.1) is communicated to the HDT 102.1. The unique location identity specifies which reader the end user is at. In this example, if a user places the mobile device on reader 150.3, at block 1712, the NFC chip 1602.3 (or BLE chip 1603.3) will communicate its unique location identity to the mobile application 120, specifying the user is at reader 150.3. If a user placed the mobile device on reader 150.2, at block 1712, the NFC chip 1602.2 (or BLE chip 1603.2) will communicate its unique location identity to the mobile application 120, specifying the user is at reader 150.2. For the explanation purposes, in method 1700 at block 1712, the user places the mobile device within a proximity or reader 150.2.

Following a successful NFC chip 1602.2 (or BLE chip 1603.2) connection (block 1712), at block 1714 the mobile application 120 communicates with the HDT 102.3 which it originally connected to over Bluetooth, commanding access to the reader 150.2, which is the reader which the user placed the mobile device on. At this step 1714, the mobile application 120 communicates with the HDT 102.3 that the mobile application 120 originally connected with. After the mobile application 120 communicates with the HDT 102.3, at block 1716, the HDT 102.3 forwards the access command from the mobile application 120 to the HDT 102.2, which is the HDT associated with the reader which the user touched the mobile device to. Thus, in the example method 1700, a connection between NFC chip 1602.2 (or BLE chip 1603.2) and the mobile application 120 has been established, and the mobile application 120 will command HDT 102.3 to give access to the reader 150.2.

At block 1718, the HDT 102.2 receives the command to grant access, and at block 1720, the HDT 102.2 references its internal memory 111 for access credentials that have already been loaded for a particular end user (block 1708). If the HDT 102.2 finds the access credentials in its internal memory 111 (block 1720), then at block 1722 the HDT 102.2 emulates the particular access card 10 associated with the user using the access credentials in its internal memory. At block 1724, the reader 150.2 then grants access to the user. If the HDT 102.2 does not find the access credentials in its internal memory 111, then at block 1726 the reader 150.2 denies access. After access is granted (block 1724) or denied (block 1726), at block 1728, the HDT 102.2 transmits a message to the HDTs (102.1 102.2, 102.3) on the mesh network to wipe their respective internal memories of the used access credential. The HDTs (102.1 102.2, 102.3) then wipe their internal memories of the used access credential. In some examples, the HDTs (102.1, 102.2, 102.3) are not connected nor creating a mesh network and the passive NFC chip(s) (1602.1, 1602.2, 1602.3) or the BLE chip(s) (1603.1, 1603.2, 1603.3) are used to instruct the mobile application 120 which HDT 102 device to connect to and transmit the card 10 information.

As utilized herein the terms “circuits” and “circuitry” refer to physical electronic components, any analog and/or digital components, power and/or control elements, such as a microprocessor or digital signal processor (DSP), or the like, including discrete and/or integrated components, or portions and/or combination thereof (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code.

Control circuitry, as used herein, includes digital and analog circuitry, discrete or integrated circuitry, microprocessors, FPGAs, DSPs, etc., software, hardware and firmware, located on one or more boards, that form part or all of a controller.

As used, herein, the term “memory” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), flash memory, solid state storage, a computer-readable medium, or the like.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z) }. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

The above-cited patents and patent publications are hereby incorporated by reference in their entirety. While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A mobile device comprising:
a mobile application configured to:
receive information corresponding to an identifier of an RFID tag; and
communicate an emulate command to an RFID emulator based on the received identifier.

2. The mobile device of claim 1, wherein the information corresponding to the physical identifier is input by a user into the mobile application via the mobile device.

3. The mobile device of claim 1, wherein the mobile device comprises a camera, and wherein the mobile application receives the information corresponding to the physical identifier from a picture taken of the RFID tag by the camera.

4. The mobile device of claim 1, wherein the mobile application communicates with the RFID emulator via one of Bluetooth NFC, Wi-Fi or Ultra WideBand.

5. The mobile device of claim 1, wherein the mobile application is further configured to:
upload the identifier to a server to determine a chip/identifying number corresponding to the RFID tag; and
receive the chip/identifying number from the server; and
wherein the emulate command is based on the received chip/identifying number.

6. The mobile device of claim 5, wherein the mobile application is further configured to upload RFID tag manufacturer or issuer identification information to the server.

7. The mobile device of claim 6, wherein the server determines the chip/identifying number by requesting the chip/identifying number corresponding to the identifier from a manufacturer or an issuer database, wherein the manufacturer or issuer is selected based on the manufacturer or issuer identification information.

8. The mobile device of claim 5, wherein the server determines the chip/identifying number by requesting the information corresponding to the physical identifier from a manufacturer or an issuer database, wherein the manufacturer or issuer is selected based in part on the identifier.

9. A system comprising:
a server;
a universal RFID device; and
a mobile application configured to:
receive information corresponding to an identifier of an RFID tag;
upload the physical identifier information to the server, wherein the server is configured to determine a chip/identifying number of the RFID tag based on the identifier;
receive the chip/identifying number of the RFID tag from the server; and
communicate an emulate command to the universal RFID device based on the received unique serial code.

10. The system of claim 9, wherein the information corresponding to the physical identifier is input by a user into the mobile application.

11. The system of claim 9, wherein the mobile application receives information corresponding to the physical identifier from a picture taken of the RFID tag.

12. The system of claim 9, wherein the mobile application communicates with the RFID emulator via one of Bluetooth NFC, Wi-Fi or Ultra WideB and.

13. The system of claim 9, wherein the mobile application communicates with the server via webservices.

14. The system of claim 9, wherein the mobile application further uploads RFID tag manufacturer or issuer identification information to the server.

15. The system of claim 9, wherein the server determines the chip/identifying number by requesting the information corresponding to the identifier from a manufacturer or an issuer database, wherein the manufacturer or issuer is selected based on the manufacturer or issuer identification information.

16. The system of claim 9, wherein the server determines the chip/identifying number by requesting the serial code corresponding to the physical identifier from a manufacturer or an issuer database, wherein the manufacturer or issuer is selected based in part on the physical identifier.

17. A method comprising:
receiving, at a mobile application, an identifier of an RFID tag;
uploading the identifier from the mobile application to a server;
determining, via the server, a chip/identifying number of the RFID tag based on the physical identifier; and
storing, in a database hosted on the server, the chip/identifying number and the identifier.

18. The method of claim 17, further comprising sending the chip/identifying number and the identifier to the mobile application.

19. The method of claim 17, further comprising emulating, via an RFID emulator in communication with the mobile application, the RFID tag.

20. The method of claim 17, wherein the mobile application communicates with the server via webservices.
